(19) United States
(12) Patent Application Publication
(10) Pub. No.: US 2025/0191027 A1
(43) Pub. Date: Jun. 12, 2025

(54) ADAPTIVE AND MOBILE ADVERTISING USING VEHICLE DISPLAYS AND POSITIONING MEASUREMENTS

(71) Applicant: QUALCOMM Incorporated, San Diego, CA (US)

(72) Inventors: Varun Amar REDDY, San Diego, CA (US); Sony AKKARAKARAN, Poway, CA (US)

(21) Appl. No.: 18/536,898

(22) Filed: Dec. 12, 2023

(51) Int. Cl. G06Q 30/0251

(52) U.S. Cl. CPC G06Q 30/0261; G06Q 30/0267

(57) ABSTRACT

Aspects presented herein may enable a UE to select a set of advertisements and/or parameter(s) for displaying the set of advertisements based on relative location and/or relative orientation of the target. In one aspect, a UE detects at least one of a relative location or a relative orientation of at least one object with respect to the UE. The UE selects at least one advertisement in a set of advertisements based on at least one of the detected relative location or the detected relative orientation of the at least one object. The UE selects a set of parameters for outputting the at least one advertisement based on at least one of the detected relative location or the detected relative orientation of the at least one object. The UE outputs, via at least one display associated with the UE, the at least one advertisement using the selected set of parameters.

### TECHNICAL FIELD

The present disclosure relates generally to communication systems, and more particularly, to wireless communication involving mobile advertising.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus detects at least one of a relative location or a relative orientation of at least one object with respect to the apparatus. The apparatus selects at least one advertisement in a set of advertisements based on at least one of the detected relative location or the detected relative orientation of the at least one object. The apparatus selects a set of parameters for outputting the at least one advertisement based on at least one of the detected relative location or the detected relative orientation of the at least one object. The apparatus outputs, via at least one display associated with the apparatus, the at least one advertisement using the selected set of parameters.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of camera-aided positioning in accordance with various aspects of the present disclosure.

FIG. 6 is a diagram illustrating an example of displaying an advertisement on one or more displays of an advertisement vehicle based on relative positioning measurements of a target vehicle in accordance with various aspects of the present disclosure.

FIG. 7 is a diagram illustrating an example of displaying multiple advertisements on multiple displays of an advertisement vehicle based on relative positioning measurements of multiple targets in accordance with various aspects of the present disclosure.

FIG. 8 is a communication flow illustrating an example of displaying location-specific advertisements based on-demand in accordance with various aspects of the present disclosure.

FIG. 9 is a diagram illustrating an example of spatially aware advertisement in accordance with various aspects of the present disclosure.

FIG. 10 is a communication flow illustrating an example of updating advertisements based on context in accordance with various aspects of the present disclosure.

FIG. 11 is a diagram illustrating an example of an advertisement vehicle displaying advertisement(s) based on feature(s) of target(s) in accordance with various aspects of the present disclosure.

FIG. 12A is a diagram illustrating an example of an advertisement vehicle displaying advertisement(s) with different settings based on environmental condition(s) in accordance with various aspects of the present disclosure.

FIG. 12B is a diagram illustrating an example of an advertisement vehicle displaying advertisement(s) with different settings based on a distance between the advertisement vehicle and a target in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

### DETAILED DESCRIPTION

Aspects presented herein may improve the overall effectiveness and user experience of mobile advertising. Aspects presented herein may enable mobile advertising to become more personalized and engaging to surrounding people based on using location information and associated positioning measurements. For example, in one aspect of the presented disclosure, an advertisement vehicle may be configured to select at least one display (e.g., among multiple displays around the advertisement vehicle) and show an advertisement to a target (e.g., a pedestrian, a driver of another vehicle, etc.) via the at least one selected display based on relative positioning measurements associated with the target. In addition, the advertisement(s) displayed by the advertisement vehicle may be location-specific advertisements, where the display(s) on the vehicle may be configured to show spatially-aware advertisement(s) based on relative positioning measurements associated with the target. In some implementations, the content of the advertisement(s) shown on display(s) of the advertisement vehicle may be adapted according to the presence of user-owned devices (including cars, vehicles) in the vicinity of the advertisement vehicle.

Aspects presented herein are directed to techniques/protocols for adaptive advertisements on vehicles. Aspects presented herein include at least the following features: (1) Selection of a vehicle display (among many such displays around the vehicle) and displaying an advertisement based on relative positioning measurements; (2) Location-specific advertisements where the vehicle display is configured to show a spatially-aware advertisement based on relative positioning measurements; (3) Advertisements shown on vehicle displays whose content is adapted according to the presence of user-owned devices (including cars, vehicles) in the vicinity.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements.

For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (NB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

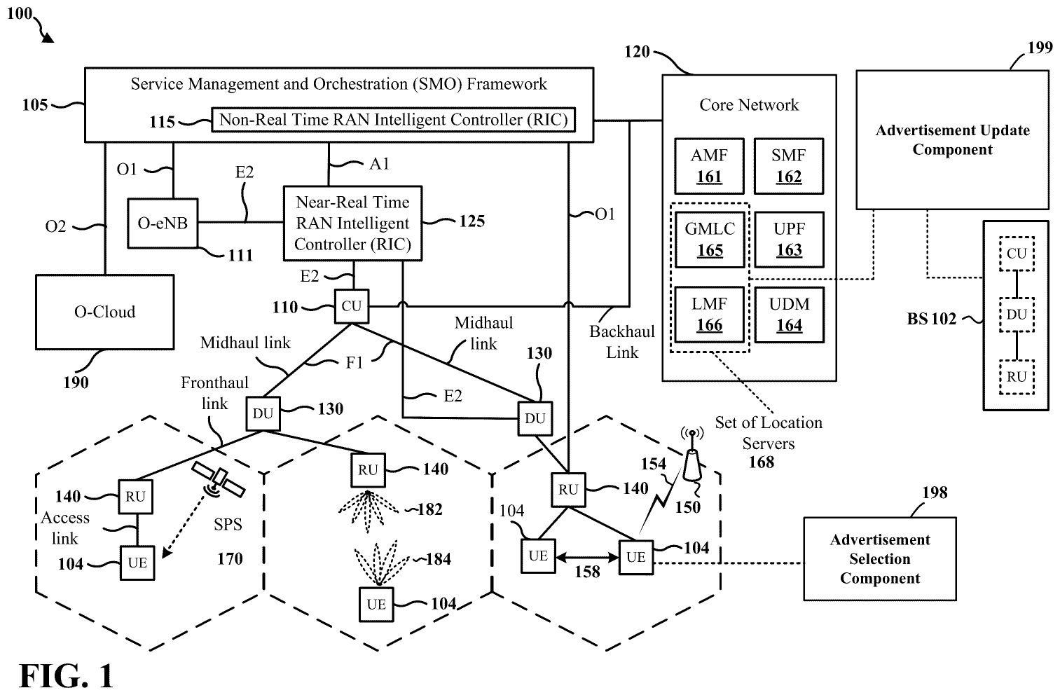

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface).

Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an advertisement selection component 198 that may be configured to detect at least one of a relative location or a relative orientation of at least one object with respect to the UE; select at least one advertisement in a set of advertisements based on at least one of the detected relative location or the detected relative orientation of the at least one object; select a set of parameters for outputting the at least one advertisement based on at least one of the detected relative location or the detected relative orientation of the at least one object; and output, via at least one display associated with the UE, the at least one advertisement using the selected set of parameters. In certain aspects, the base station 102 or the one or more location servers 168 may have an advertisement update component 199 that may be configured to provide advertisement updates for the UE 104.

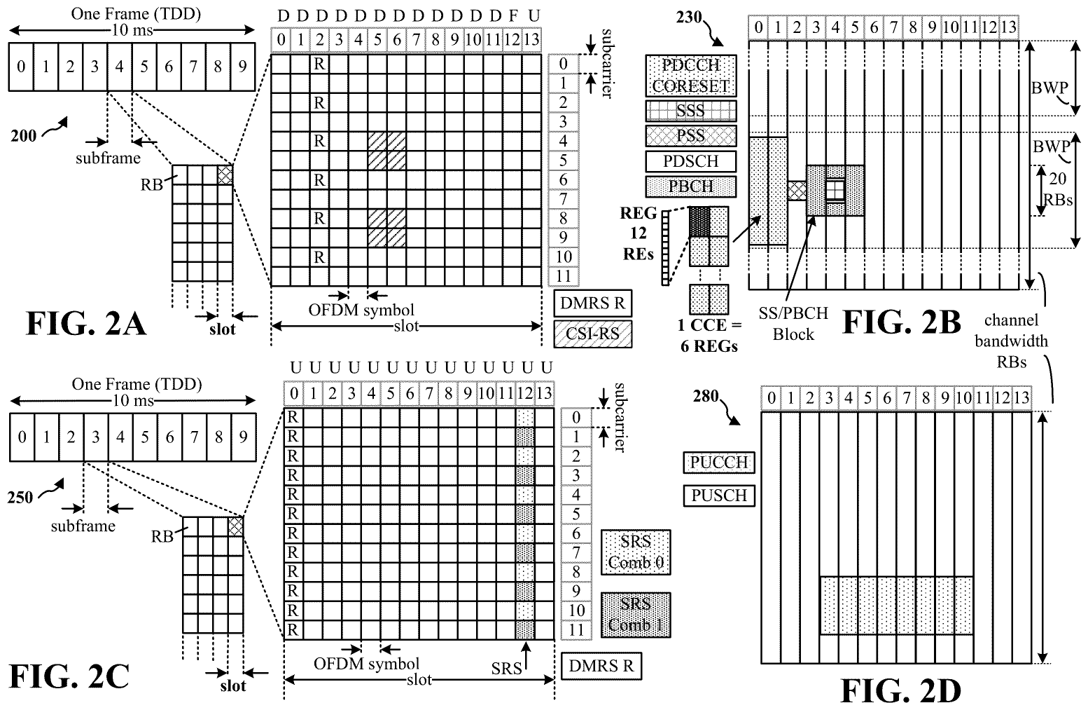

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

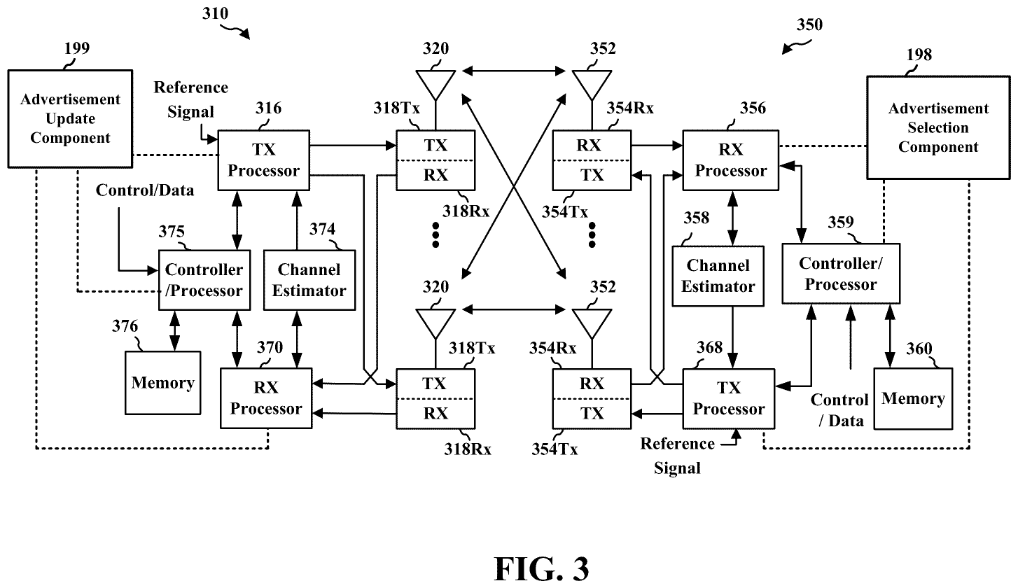

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the advertisement selection component 198 of FIG. 1.

At least one of the TX processor 316, the RX processor 370, and the controller/processor 375 may be configured to perform aspects in connection with the advertisement update component 199 of FIG. 1.

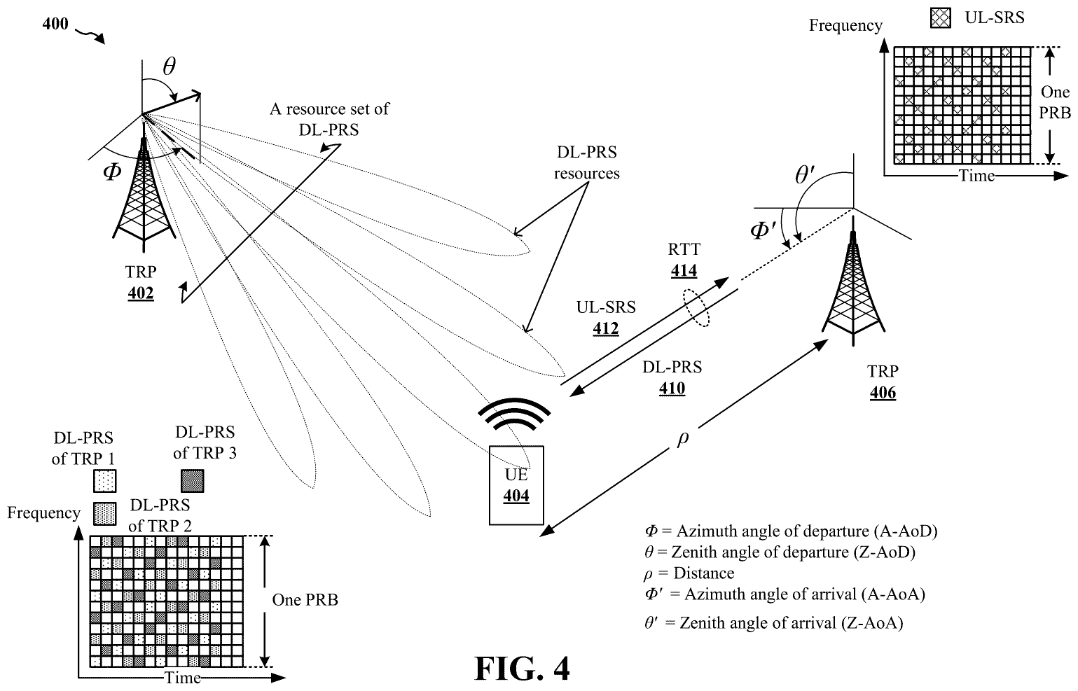

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, tracking reference signal (TRS), phase tracking reference signal (PTRS), cell specific reference signal/cell reference signal (CRS), CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to Global Navigation Satellite Systems (GNSS)-based positioning (e.g., positioning based on reception of signals from satellites) and network-based positioning (e.g., as described in connection with FIG. 4), camera-based positioning has also been developed to provide alternative/additional positioning mechanisms/modes. Camera-based positioning, which may also be referred to as “camera-based visual positioning,” “visual positioning” and/or “vision-based positioning,” is a positioning mechanism/mode that uses images captured by at least one camera to determine the location of a target (e.g., a UE or a transportation that is equipped with the at least one camera, an object that is in view of the at least one camera, etc.). For example, images captured by the dashboard camera (dash cam) of a vehicle may be used for calculating the three-dimensional (3D) position and/or 3D orientation of the vehicle while the vehicle is moving. Similarly, images captured by the camera of a mobile device may be used for estimating the location of the mobile device user or the location of one or more objects in the images. In another example, a camera (or a UE equipped with the camera) may determine its position by matching object(s) in images captured by the camera with object(s) in a map (e.g., a high-definition (HD) map), such as specified buildings, landmarks, etc. In some implementations, camera-based positioning may provide centimeter-level and 6-degrees-of-freedom (6DOF) positioning. 6DOF may refer to a representation of how an object moves through 3D space by either translating linearly or rotating axially (e.g., 6DOF=3D position+3D attitude). For example, a single-degree-of-freedom on an object may be controlled by the up/down, forward/back, left/right, pitch, roll, or yaw. Camera-based positioning has great potential for various applications, especially in satellite signal (e.g., GNSS/GPS signal) degenerated/unavailable environments.

In some scenarios, images captured by a camera may also be used for improving the accuracy/reliability of other positioning mechanisms/modes (e.g., the GNSS-based positioning, the network-based positioning, etc.), which may be referred to as “vision-aided positioning,” “camera-aided positioning,” “camera-aided location,” and/or “camera-aided perception,” etc. For example, while GNSS and/or inertial measurement unit (IMU) may provide good positioning/localization performance, when GNSS measurement outage occurs, the overall positioning performance might degrade due to IMU bias drifting. Thus, images captured by the camera may provide valuable information to reduce errors. For purposes of the present disclosure, a positioning session (e.g., a period of time in which one or more entities are configured to determine the position of a UE) that is associated with camera-based positioning or camera-aided positioning may be referred to as a camera-based positioning session or a camera-aided positioning session. In some examples, the camera-based positioning and/or the camera-aided positioning may be associated with an absolute position of the UE, a relative position of the UE, an orientation of the UE, or a combination thereof.

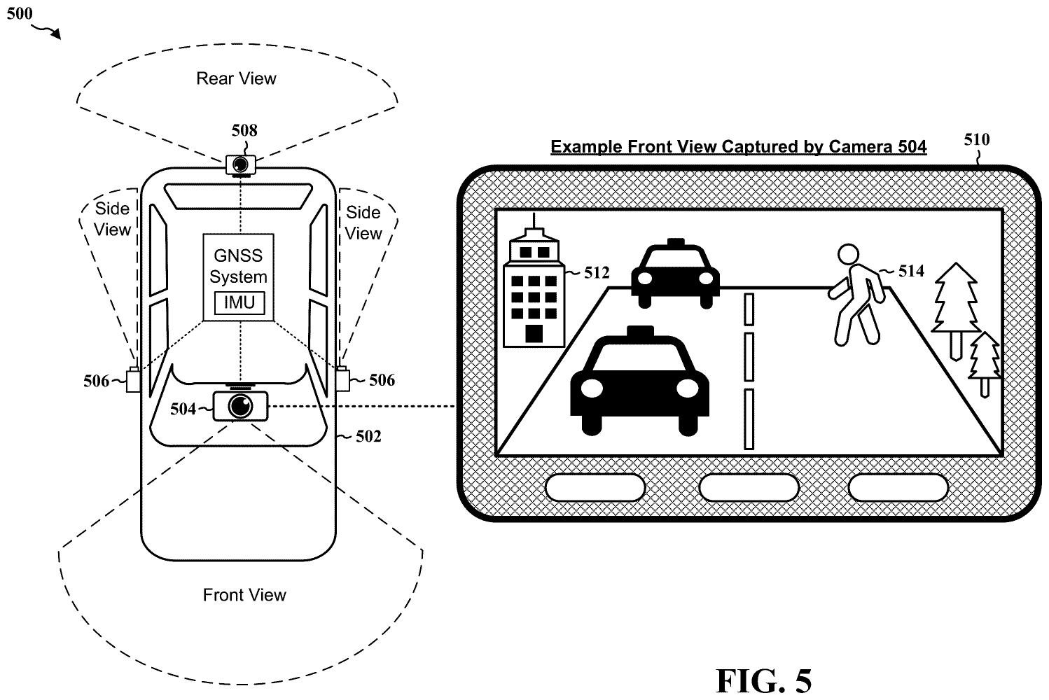

FIG. 5 is a diagram 500 illustrating an example of camera-aided positioning in accordance with various aspects of the present disclosure. A vehicle 502 may be equipped with a GNSS system and a set of cameras, which may include a front camera 504 (for capturing the front view of the vehicle 502), side cameras 506 (for capturing the side views of the vehicle 502), and/or a rear camera 508 (for capturing the rear view of the vehicle 502), etc. In some examples, the GNSS system may further include or be associated with at least one IMU (e.g., a GNSS+IMU system). While FIG. 5 uses the vehicle 502 as an example, it is merely for illustration purposes. Aspects presented herein may also apply to other types of transportations (e.g., motorcycles, bicycles, buses, trains, etc.), devices (e.g., UEs on pedestrians), and/or positioning mechanisms/modes (e.g., network-based positioning described in connection with FIG. 4). In addition, for purposes of the present disclosure, a positioning mechanism/mode (e.g., GNSS-based positioning, network-based positioning, etc.) that uses at least one sensor (e.g., an IMU, a camera) to assist the positioning may be referred to as a sensor fusion positioning.

The GNSS system may estimate the location of the vehicle 502 based on receiving GNSS signals transmitted from multiple satellites (e.g., based on performing GNSS-based positioning). However, when the GNSS signals are not available or weak, such as when the vehicle 502 is in an urban area or in a tunnel, the estimated location of the vehicle 502 may become inaccurate. Thus, in some implementations, the set of cameras on the vehicle 502 may be used for assisting the positioning, such as for verifying whether the location estimated by the GNSS system based on the GNSS signals is accurate. For example, as shown at 510, images captured by the front camera 504 of the vehicle 502 may include/identify a specific building 512 (which may also be referred to as a feature) that is with a known location, and the vehicle 502 (or the GNSS system or a positioning engine associated with the vehicle 502) may determine/verify whether the location (e.g., the longitude and latitude coordinates) estimated by the GNSS system is in proximity to the known location of this specific building 512. Thus, with the assistance of the camera(s), the accuracy and reliability of the GNSS-based positioning may be further improved. For purposes of the present disclosure, a GNSS system that is associated with a camera (e.g., capable of performing camera-aided/based positioning) may be referred to as a “GNSS+camera system,” or a “GNSS+IMU+camera system” (if the GNSS system is also associated with/includes at least one IMU).

In some example, a camera may also be used for determining the location (e.g., an absolute location, a relative location, etc.) of one or more objects in the field of view (FOV) of the camera. For example, as shown at 510, the front camera 504 or a UE/system associated with the front camera 504 may determine a relative location between the vehicle 502 and a pedestrian 514 and/or an absolute location of the pedestrian 514 (e.g., if the location of the vehicle 502 is known) based on the image captured by the front camera 504.

Advertising has been a continuously growing industry, where a variety of latest technologies has been used to make advertisements (ads) more personalized, widespread, and/or engaging to users. For example, some vendors have utilized the concept of mobile advertising by displaying advertisement(s) on vehicle (which may be referred to as “advertisement vehicle” hereafter for purposes of the disclosure), where these advertisement vehicles may be configured to simply display a fixed set of advertisements without much dependence on specific criteria. The display(s) on advertisement vehicles may include liquid crystal display (LCD)/light emitting diode (LED) displays, automotive smart glass, and/or a more economical solution such as electronic paper (e-paper) (e.g., similar to what is used in electronic shelf label displays). An automotive smart glass (or simply smart glass) may refer to a type of glass (or a film on glass) that is capable of being switched to become a display, such that visual contents may be shown/displayed on the glass. The smart glass may be configured to remain transparent, partially transparent, or non-transparent while the contents are displayed. For purposes of the present disclosure, mobile advertising may refer to a form of advertising that appears on mobile devices such as smartphones, tablets, and display panels on vehicles using wireless connections. A vehicle may refer to a machine, typically with wheels and an engine, used for transporting people or goods, especially on land.

Aspects presented herein may improve the overall effectiveness and user experience of mobile advertising. Aspects presented herein may enable mobile advertising to become more personalized and engaging to surrounding people based on using location information and associated positioning measurements. For example, in one aspect of the presented disclosure, an advertisement vehicle may be configured to select at least one display (e.g., among multiple displays around the advertisement vehicle) and show an advertisement to a target (e.g., a pedestrian, a driver of another vehicle, etc.) via the at least one selected display based on relative positioning measurements associated with the target. In addition, the advertisement(s) displayed by the advertisement vehicle may be location-specific advertisements, where the display(s) on the vehicle may be configured to show spatially-aware advertisement(s) based on relative positioning measurements associated with the target. In some implementations, the content of the advertisement(s) shown on display(s) of the advertisement vehicle may be adapted according to the presence of user-owned devices (including cars, vehicles) in the vicinity of the advertisement vehicle.

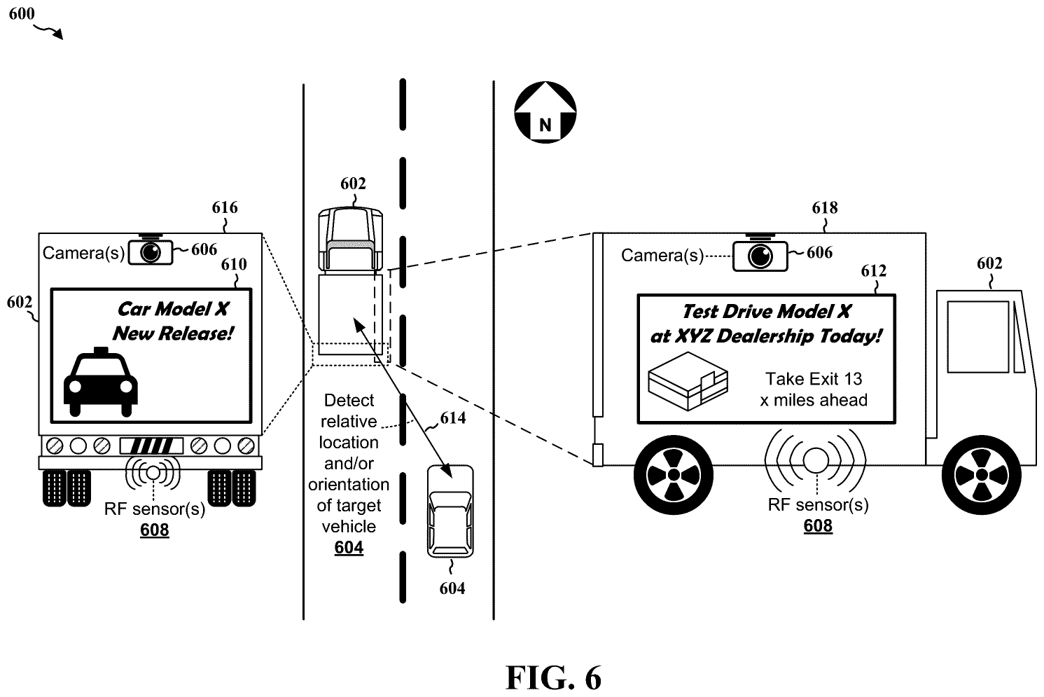

FIG. 6 is a diagram 600 illustrating an example of displaying an advertisement on one or more displays of an advertisement vehicle based on relative positioning measurements of a target vehicle in accordance with various aspects of the present disclosure. While the example here shows an advertisement vehicle displaying an advertisement towards a target vehicle, the target vehicle may also be a pedestrian, a cyclist, and/or a motorist, etc.

As shown by the diagram 600, an advertisement vehicle 602 (e.g., which may include an on-board unit (OBU) of the advertisement vehicle 602, a device running an advertisement application, or a display system associated with the advertisement vehicle 602, and collectively be referred to as a UE) may include multiple displays, such as a first display 610 (e.g., on the rear of the advertisement vehicle 602), a second display 612 (on one side/right side of the advertisement vehicle 602), and up to X displays. The displays may be LCD/LED displays, smart glasses, e-papers, or a combination thereof. The owner of the advertisement vehicle 602 may have subscribed to a service (e.g., an advertising service) that allows the playback of (pre-) configured/downloaded advertisements (e.g., images or video) on these displays. In addition, the advertisement vehicle 602 may also include a plurality of sensors that may be used for detecting/identifying location, relative location, and/or relative orientation of one or more objects surrounding the advertisement vehicle 602. For example, the plurality of sensors may include a set of cameras 606 and/or a set of RF sensor(s) 608 (e.g., ultrawideband (UWB) sensor(s), radar(s), light detection and ranging (lidar) sensor(s), or a combination thereof). In some examples, the process of using RF sensor(s) for detecting object(s) (e.g., the presence, the distance, and/or the direction of the object(s), etc.) may be referred to as “sensing,” “sensing measurement,” or “RF sensing,” etc.

In one aspect, the advertisement vehicle 602 may be configured to perform positioning or sensing measurements to detect the presence of object(s)/target(s) (e.g., people and other vehicles, etc.) in its vicinity (e.g., within a threshold/defined distance of the advertisement vehicle 602). If presence of object(s) is detected, based on the positioning or sensing measurements, the advertisement vehicle 602 may also be able to determine the location of the object(s), and/or the relative location/orientation of the object(s) with respect to the vehicle. Then, the advertisement vehicle 602 may select at least one display to output/show an advertisement or multiple advertisements based on the location/relative location/relative orientation of the object(s), such as displaying the advertisement towards the object(s). In addition, the advertisement vehicle 602 may also select and display the advertisement(s) to be displayed based on the location/relative location/relative orientation of the object(s).

For example, the advertisement vehicle 602 may be configured to detect the presence of target(s) (e.g., vehicles, cyclists, pedestrians, etc.) around the advertisement vehicle 602 using its sensor(s), such as using the set of cameras 606 and/or the set of RF sensors 608. Then, as shown at 614, the advertisement vehicle 602 may detect that a target vehicle 604 is in its proximity (e.g., within a threshold/defined distance of the advertisement vehicle 602). Based on the detection of the target vehicle 604, the advertisement vehicle 602 may also determine/calculate the location, the relative location, and/or the relative orientation of the target vehicle 604. For example, based on the positioning or sensing measurements from the set of cameras 606 and/or the set of RF sensors 608, the advertisement vehicle 602 may determine that the target vehicle 604 is at the southeast of the advertisement vehicle 602 and approximately X meters away.

Utilizing the (relative) location/orientation information of the target vehicle 604, the advertisement vehicle 602 may select at least one of its displays to show/output one or more advertisements to the target vehicle 604. For example, as shown at 616 and 618, the advertisement vehicle 602 may use the first display 610 and the second display 612 to display an advertisement to the target vehicle 604. In another example, the advertisement vehicle 602 may use the first display 610 to display the advertisement as shown at 616 while the target vehicle 604 is at the rear of the advertisement vehicle 602. When the target vehicle 604 is bypassing the advertisement vehicle 602 from the right, the advertisement vehicle 602 may switch (and resume) displaying the advertisement using the second display 612 as shown at 618. As such, the advertisement vehicle 602 may be configured to continuously track the movement (e.g., direction and orientation) of the target vehicle 604, and display the advertisement using a most suitable display (e.g., the one facing the target vehicle 604 or the one that is best viewed by the target vehicle, etc.) based on the movement of the target vehicle 604.

In some examples, based on the location of the advertisement vehicle 602 and/or the target vehicle 604, the advertisement may also include a direction to a business associated with the advertisement. For example, as shown at 618, the advertisement may include a direction to a car dealership that enables a customer to test drive a car model shown in the advertisement. As such, the advertisement vehicle 602 may also be configured to select the advertisement(s) from a set of advertisements (e.g., stored at a memory of the advertisement vehicle 602 or downloaded from a server) based on the location, relative location, relative orientation, and/or information related to the target vehicle 604 (discussed in more details below).

In some implementations, under certain conditions, in the interest of driver safety, advertisement(s) may be configured to be static images if a target (e.g., the target vehicle 604) is detected to be moving, dynamic, or the (relative) speed of the target is above a (relative) speed threshold. For example, when the advertisement vehicle 602 and/or the target vehicle 604 is moving, when the target vehicle 604 is moving above a velocity threshold, and/or when the relative velocity between the advertisement vehicle 602 and the target vehicle 604 is above a relative velocity threshold, etc., the advertisement vehicle 602 may be configured to display the advertisement using static images. In another example, when both the advertisement vehicle 602 and/or the target vehicle 604 are on a specified place, such as on a highway, the advertisement vehicle 602 may be configured to display the advertisement using static images.

On the other hand, the advertisement may be updated/configured to display a series of images or a video if the advertisement vehicle 602 and/or the target vehicle 604 is static (e.g., not moving) or the velocity/relative velocity of the advertisement vehicle 602/target vehicle 604 is below a velocity/relative velocity threshold. As such, the nature of the advertisement (e.g., whether to display an advertisement as static image(s) or video(s)) may be configured to be a function of the velocity of an advertisement vehicle (e.g., the advertisement vehicle 602 that is displaying the advertisement), or the velocity of another vehicle(s) (e.g., the target vehicle 604), or the difference between their velocities (e.g., the relative velocity between the advertisement vehicle 602 and the target vehicle 604).

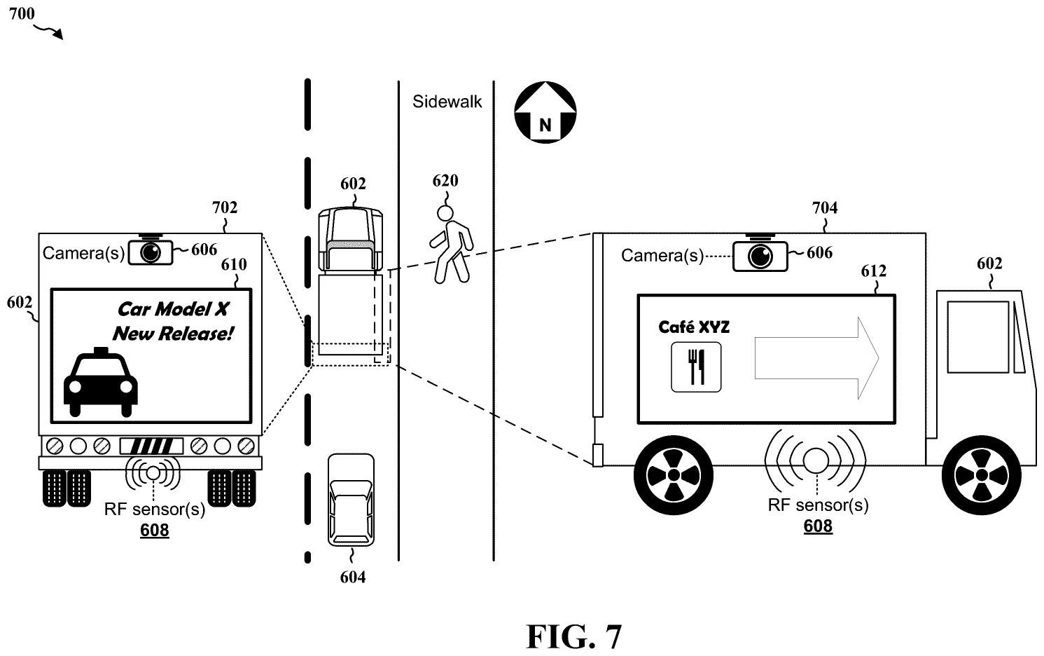

In another example, as shown by a diagram 700 of FIG. 7, when multiple objects/targets are detected, the advertisement vehicle 602 may be configured to use different displays to display different advertisements to different objects or targets (e.g., each display showing at least one advertisement targeting at least one target). For example, if the advertisement vehicle 602 detects that there is a target vehicle 604 on its south (e.g., behind the advertisement vehicle 602) and a pedestrian 620 on its east (e.g., on the right side of the advertisement vehicle 602), the advertisement vehicle 602 may use the first display 610 to display a first advertisement to the target vehicle 604 as shown at 702, and use the second display 612 to display a second advertisement to the pedestrian 620 as shown at 704.

In another aspect of the present disclosure, advertisement(s) displayed by an advertisement vehicle (e.g., the advertisement vehicle 602) may be configured to be location-specific and/or spatially-aware advertisement(s). For example, the advertisement(s) shown on an advertisement vehicle may be associated with a subscription service operated by a remote server (e.g., by an advertising service company). The owner of the advertisement vehicle may choose to enable the display of advertisement(s) for some incentive provided by the advertising service company. The advertising service company may also invite businesses to display advertisements (on subscribed advertisement vehicles) for some price. Example incentives may include some fees and free service(s), such as use of free electric vehicle (EV) charging services (for certain amount) where the charging may take place through an infrastructure installed under the road (as the car is moving) or it may take place at stationary charging stations, etc. Hence, the nature/content/database of the advertisements may be updated periodically or on-demand through interactions between an advertisement vehicle and the server (e.g., between the owner of advertisement vehicle and the advertising service company).

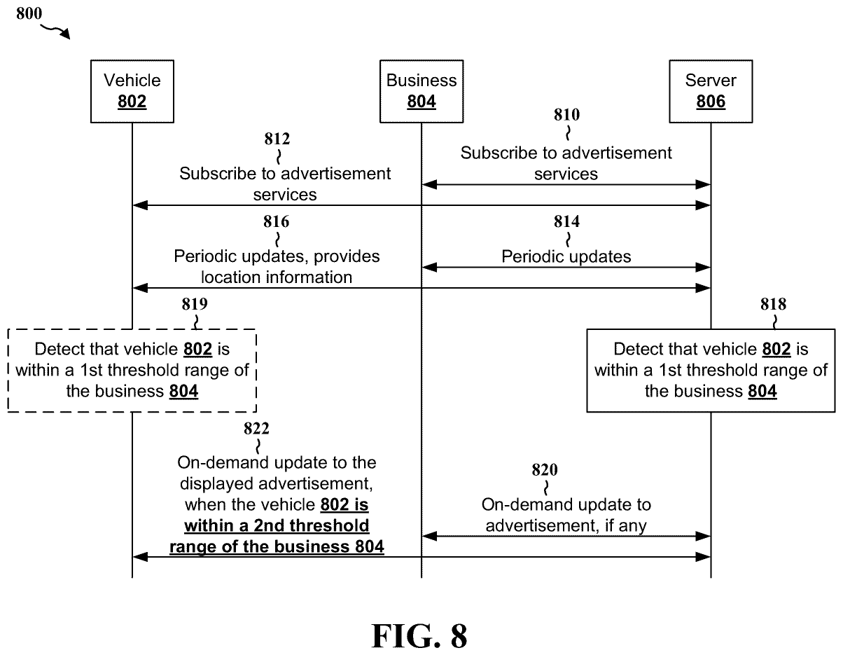

FIG. 8 is a communication flow 800 illustrating an example of displaying location-specific advertisements based on-demand in accordance with various aspects of the present disclosure. The numberings associated with the communication flow 800 do not specify a particular temporal order and are merely used as references for the communication flow 800. In some implementations, when an advertisement vehicle (e.g., the advertisement vehicle 602) is in the vicinity of a subscribed (or compatible) business (e.g., a business that has purchased rights to advertise on the advertisement vehicle), location-specific advertisement(s) may be displayed on-demand.

As shown at 810, a business 804 may subscribe an advertisement service with a server 806 (e.g., operated by an advertising service company), such that the business 804 may display its advertisement(s) using means provided by the server 806, such as displaying advertisements based on mobile advertising (i.e., displaying advertisements via advertisement vehicles or mobile devices).

As shown at 812, an advertisement vehicle 802 may also subscribe to the server 806 for displaying of advertisements, where the server 806 may provide the advertisement vehicle 802 incentives (e.g., fees, free services, etc.) and/or equipments for displaying the advertisements (e.g., the equipments may include other uses other than displaying advertisement as an incentive), etc.

As shown at 814, the business 804 may perform periodic updates with the server 806, such as renewing its subscription services, updating its advertisements (e.g., adding new promotions, removing expired promotions, changing contents, etc.), and/or modifying settings related to displaying of advertisements, etc.

As shown at 816, the advertisement vehicle 802 may also perform periodic or on-demand updates with the server 806, such as updating/modifying its advertisement settings (e.g., what types of advertisements to display) and/or providing its location the server 806 (e.g., determined based on GNSS-based and/or network-based positioning). For purposes of the present disclosure, on-demand may refer to a first entity providing a response to a second entity or perform an action based on a request (e.g., a demand) from the second entity. For example, an on-demand update may refer to the server 806 transmitting a request to the advertisement vehicle 802 to perform an update, or the advertisement vehicle 802 transmitting a request to the server 806 to perform an update, etc.

As shown at 818, based on the location of the advertisement vehicle 802, the server 806 may detect whether the advertisement vehicle 802 is within a first threshold range (e.g., 5 kilometers, 10 kilometers, etc.) of the business 804 or within a defined area associated with the business 804 (e.g., when the advertisement vehicle 802 is within the same city and/or the same zip/postal code as the business 804, etc.). Depending on the implementations, in some examples, the detection of whether the advertisement vehicle 802 is within the first threshold range of the business 804 or within a defined area associated with the business 804 may also be performed by the advertisement vehicle 802 such as shown at 819.

At shown at 820, the business 804 and/or the server 806 may initiate/perform an on-demand update if any. In some examples, this on-demand update may be based on the advertisement vehicle 802 being within the first threshold range of the business 804 (e.g., if no advertisement vehicles are in the vicinity of the business 804, then on-demand update may not be available). For example, based on knowing that the advertisement vehicle 802 is within the first threshold range of the business 804, the server 806 may send an inquiry or a notification to the business 804 regarding whether the business 804 has any advertisement or updated advertisement (e.g., a promotion specific to/around the time/day when the advertisement vehicle 802 is around). If the business 804 has new/updated advertisement(s), the business 804 may send the new/updated advertisement(s) to the server 806. In another example, if the business 804 has a new/updated advertisement which it would like to display, the business 804 may send an on-demand request to the server 806 and requesting the server 806 to display the new/updated advertisements via advertisement vehicles in the vicinity of the business 804.

As shown at 822, the advertisement vehicle 802 may continue to update its location with the server 806 or detecting the distance between the advertisement vehicle 802 and the business 804 (e.g., if the distance detection is performed at the advertisement vehicle 802 as shown at 819). Then, if the advertisement vehicle 802 is within a second threshold range (e.g., 3, kilometer, 1 kilometer, etc.) of the business 804, the server 806 may transmit and configure the advertisement vehicle 802 to display the advertisement for the business 804 (e.g., based on the on-demand update/inquiry/request discussed at 820), or the advertisement vehicle 802 may request/retrieve updated advertisement(s) for the business 804 from the server 806. Note the configuration with the first threshold range and the second threshold range may enable the business 804 and/or the server 806 to have more time and opportunity to perform the on-demand update/inquiry/request. Aspects presented herein may also be applied using just one threshold range. For example, the advertisement vehicle 802 may be configured to display the advertisement for the business 804 when it is within a threshold range of the business 804 or within a defined area associated with the business 804.

In another aspect of the present disclosure, the advertisement(s) displayed by the advertisement vehicle 802 may also be configured to be spatially aware. For instance, visual cues such as an arrow may be displayed, with the start of the arrow pointing towards the person/vehicle on the outside, and the end of the arrow pointing towards the direction of the business. Such visual cues may adapt and change direction as the relative position changes (person walks towards/away from the vehicle; vehicle drives towards/away from the person/another vehicle).

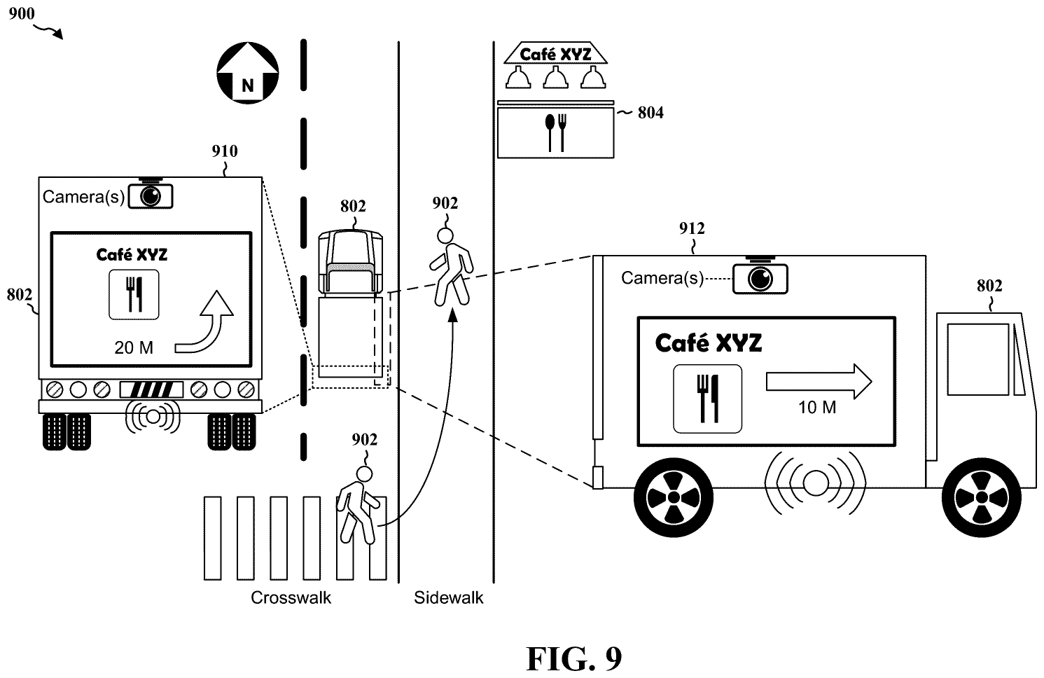

FIG. 9 is a diagram 900 illustrating an example of a spatially aware advertisement in accordance with various aspects of the present disclosure. As shown at 910, when the advertisement vehicle 802 detects a pedestrian 902 (e.g., a target) is at the rear/south of the advertisement vehicle 802, the advertisement vehicle 802 may use its rear display to show an advertisement related to the business 804 (e.g., a café) that is in proximity to the advertisement vehicle 802, which include a direction to the business 804 (e.g., 20 meters after turning left from the crosswalk). Such configuration may specify the advertisement vehicle 802 to also know the location/relative location of the business 804. Then, as shown at 912 as the pedestrian 902 moves to the right/east side of the advertisement vehicle 802 (e.g., from the crosswalk to the sidewalk), based on tracking the movement (e.g., the relative location/orientation) of the pedestrian 902, the advertisement vehicle 802 may use its right side display to show the advertisement related to the business 804, which include an updated direction to the business 804 (e.g., now 10 meters ahead of the direction pointed by the arrow). As such, the advertisement vehicle 802 may be configured to select advertisement(s) also based on the relative location/orientation of a target.

In another aspect of the present disclosure, advertisement(s) displayed by an advertisement vehicle (e.g., the advertisement vehicle 602, 802) may be selected/updated/modified based on various context. For example, the location of an advertisement vehicle may be used to derive contextual information about the surroundings. If the advertisement vehicle passes through a “hot-spot” for tourists (e.g., a landmark, a theme park, a national park, etc.), the advertisement vehicle may advertise travel-related advertisements/promotions/deals pertaining to hotels, restaurants, and other activities in the area. In another example, time information, such as the time of the day, the time of the year, the seasons, etc., may also be used to derive context for the advertisement(s). For instance, advertisements pertaining to school supplies may be shown when the advertisement vehicle is passing by a school area and during school hours, advertisements pertaining to restaurants may be shown (or have a higher chance of showing) during lunch and dinner hours, and advertisement related to an upcoming holiday may be shown few days before that holiday, etc.

As described in connection with FIGS. 6 and 7, the advertisement(s) may be configured to be displayed towards people and/or target vehicles in the surrounding area of an advertisement vehicle, where the detection of the people, target vehicles, and/or other devices may be done through a negotiation protocol, or through computer vision methods (camera feed may be used to identify a vehicle/pedestrian in the vicinity as discussed in connection with FIG. 5). Owners of advertisement vehicles who subscribe to the advertising service (for their vehicle displays) may be registered through an application on their mobile devices, which in turn may gather user characteristics, desires, and other statistics. In addition to detecting the presence of a person or a vehicle in the vicinity, their user profile or personal desire information may also be used to customize the displayed advertisement to be more targeted towards a respective person/vehicle.

In some implementations, owners of the advertisement vehicles may also designate permissions, characteristics, or desires for the advertisements that are displayed on their advertisement vehicles. For example, an owner who does not consume alcohol may choose not to display advertisement related to alcohol, despite being close to a liquor store or a bar. In another example, an owner may also be provided with a prompt to approve/disapprove a certain advertisement, before it is shown on the display. Such prompts may be provided to the owner when the advertisement vehicle is stationary, so that the owner may not be distracted from driving.

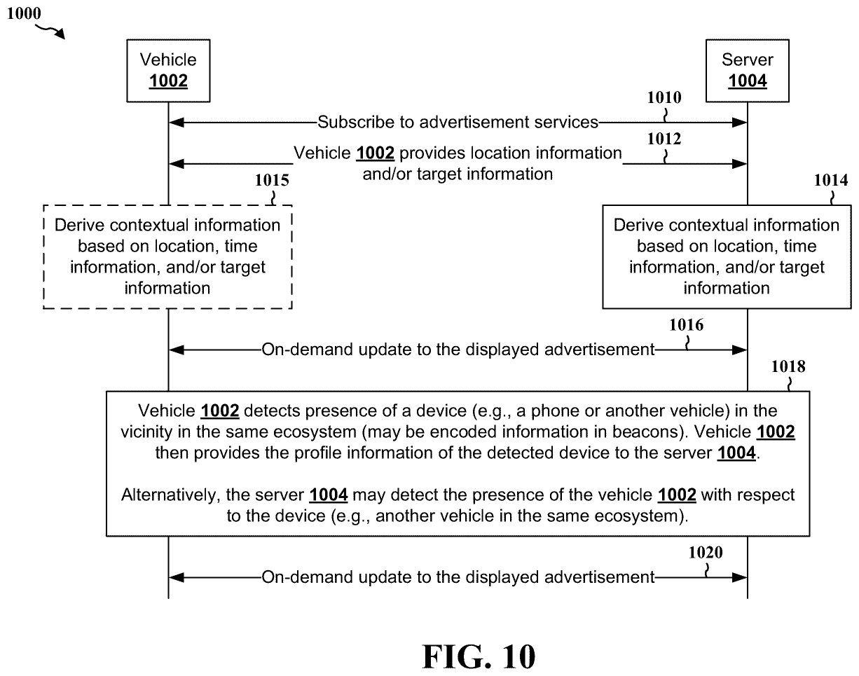

FIG. 10 is a communication flow 1000 illustrating an example of updating advertisements based on context in accordance with various aspects of the present disclosure. The numberings associated with the communication flow 1000 do not specify a particular temporal order and are merely used as references for the communication flow 1000.

As shown at 1010, an advertisement vehicle 1002 (e.g., the advertisement vehicle 602, 802) may subscribe to a server 1004 (e.g., operated by an advertising service company) for displaying advertisements, where the server 1004 may provide the advertisement vehicle 1002 incentives and/or equipments for displaying the advertisements, etc.

As shown at 1012, the advertisement vehicle 1002 may be configured to provide its location to the server 1004 (e.g., periodically or upon a triggering condition). In some implementations, after the advertisement vehicle 1002 detects a target (e.g., a pedestrian, a vehicle, etc.), the advertisement vehicle 1002 may also be configured to identify a set of features related to the detected target, such as an estimated age or age group, a gender, a height, a brand, a color, and/or a condition of the detected target (hereafter “target information”). Then, the advertisement vehicle 1002 may also provide this target information to the server 1004.

As shown at 1014, based on the location information of the advertisement vehicle 1002, the time information (e.g., the date, the time of the day, the season, etc.), and/or the target information, the server 1004 may derive a set of advertisements to be displayed on the advertisement vehicle 1002. For example, based on the location of the advertisement vehicle 1002, the server 1004 may select a set of advertisements that are related to businesses in proximity (e.g., within a distance threshold or within a defined area) to the advertisement vehicle 1002. In another example, based on the time information, the server 1004 may select a set of advertisements that are related to the time of the day/year (e.g., displaying café advertisements during breakfast time, vacation related advertisements during summer season, gift related advertisements during holidays, etc.). In another example, based on the target information, the server 1004 may select a set of advertisements that are related to the target. Similarly, depending on implementations, the derivation of the set of advertisements based on the location, the time information, and/or the target information may also be performed by the target vehicle 1002 (e.g., at 1015 in FIG. 10). For example, instead of sending the target information to the server 1004, the advertisement vehicle 1002 may also be configured to select one or more advertisements from a set of advertisements based on the location information of the advertisement vehicle 1002, the time information (e.g., the date, the time of the day, the season, etc.), and/or the target information.

As shown at 1016, after deriving the set of advertisement(s) (either by the server 1004 or the advertisement vehicle 1002), the server 1004 may update the advertisement vehicle 1002 with the set of advertisement(s) or on-demands, and the advertisement vehicle 1002 may display the updated/derived set of advertisement(s) in response.

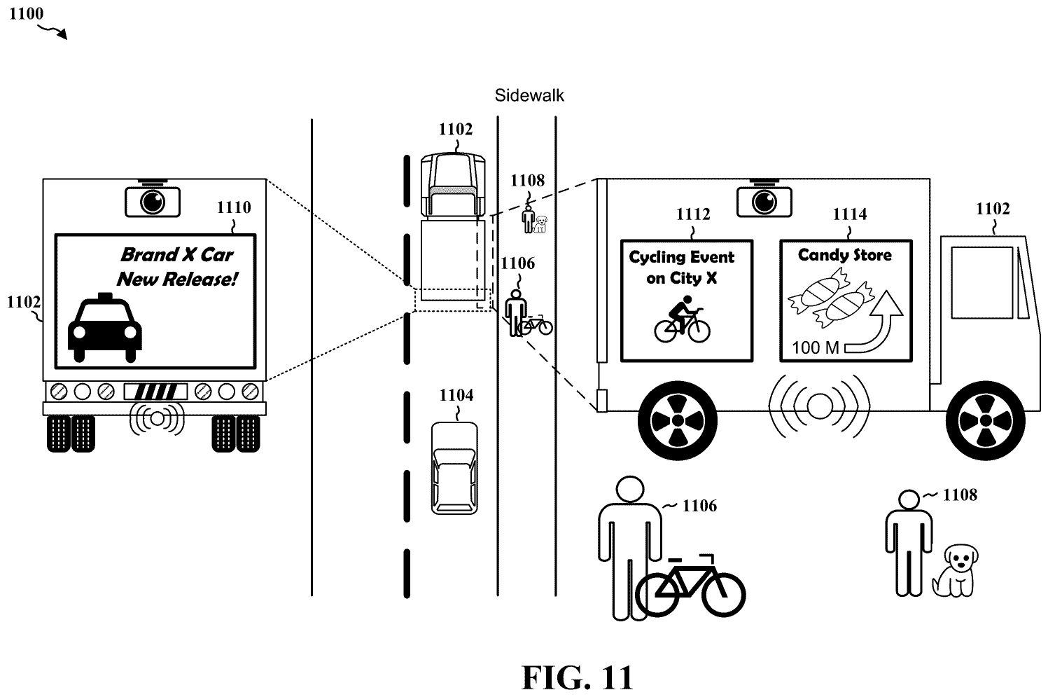

FIG. 11 is a diagram 1100 illustrating an example of an advertisement vehicle displaying advertisement(s) based on feature(s) of target(s) in accordance with various aspects of the present disclosure. In some implementations, an advertisement vehicle may be configured to detect and identify feature(s) associated with a target, and select and display an advertisement based on the detected/identified features. For example, an advertisement vehicle 1102 (e.g., the advertisement vehicle 602, 802, 1002) may detect three targets in its vicinity, which may include a target vehicle 1104, a first pedestrian 1106, and a second pedestrian 1108. In one example, the advertisement vehicle 1102 may be configured to identify the brand of the target vehicle 1104 (or transmit the image of the target vehicle 1104 to a server for brand identification). Then, as shown at 1110, based on the identified brand of the target vehicle 1104, the advertisement vehicle 1102 may display advertisement(s) related to the identified brand (e.g., a new car model released by that brand) using a rear display of the advertisement vehicle 1102. In another example, the advertisement vehicle 1102 may be configured to identify an item used by or associated with the user. Then, based on the identification of the item associated with the user, the advertisement vehicle 1102 may display advertisement(s) related to the identified item. For example, the advertisement vehicle 1102 may identify that the first pedestrian 1106 is holding a bicycle. Then, as shown at 1112, based on the identification of the bicycle associated with the first pedestrian 1106, the advertisement vehicle 1102 may display advertisement(s) related to a bicycle or a cycling event using a first side display of the advertisement vehicle 1102. In another example, the advertisement vehicle 1102 may be configured to identify the age/age group of a target, and display advertisement(s) related to the age/age group of the target. For example, the advertisement vehicle 1102 may identify that the second pedestrian 1108 is a teenager based on its appearance and/or heights. Then, as shown at 1114, based on the identified age/age group associated with the second pedestrian 1108, the advertisement vehicle 1102 may display advertisement(s) related to that age/age group (e.g., a candy shop or a pet shop, etc.) using a second side display of the advertisement vehicle 1102. In some implementations (discussed below), the advertisement vehicle 1102 may also be configured to adjust display parameters based on the feature(s) associated with the target. For example, based on the distance, angle, age, and/or height of a target, the advertisement vehicle 1102 may adjust the displayed advertisement to make it more suitable to the viewing angle of the target.

Referring back to FIG. 10, in some implementations, as shown at 1018, the advertisement vehicle 1002 may be configured to detect the presence of a device (e.g., a phone, another advertisement vehicle, etc.) in its vicinity that is also in the same ecosystem as the advertisement vehicle 1002 (e.g., a device using/registering same advertisement/communication platform, another advertisement vehicle, etc.), such as based on using encoded information in transmitted/received beacons. Then, the advertisement vehicle 1002 may provide profile information related to the device (or the owner of the device) to the server 1004, such as the location and/or feature(s) associated with the owner of the device (if available). In response, at shown at 1020, the server 1004 may select a set of advertisements to be displayed by the advertisement vehicle 1002 towards the device (or the owner of the device) based on the profile information. Alternatively, or additionally, the server 1004 may also be configured to detect the presence of the advertisement vehicle 1002 with respect to the device (if the device provides its location to the server 1004). Then, the server 1004 may load profile information related to the device (or the owner of the device), and select a set of advertisements to be displayed by the advertisement vehicle 1002 towards the device (or the owner of the device) based on the loaded profile information.

In another aspect of the present disclosure, an advertisement vehicle (e.g., the advertisement vehicle 602, 802, 1002, 1102) may be configured to select a set of parameters for displaying advertisement(s) based on the environmental condition(s), the time of the day, feature(s) associated with a target, and/or the location/relative location/the relative orientation of the target. The set of parameters may include the display size for the advertisement(s), an amount of information to be displayed for the advertisement(s), the font size for the advertisement(s), a set of colors to be used for the advertisement(s), a display brightness for the advertisement(s), and/or a display angle for the advertisement(s), etc.

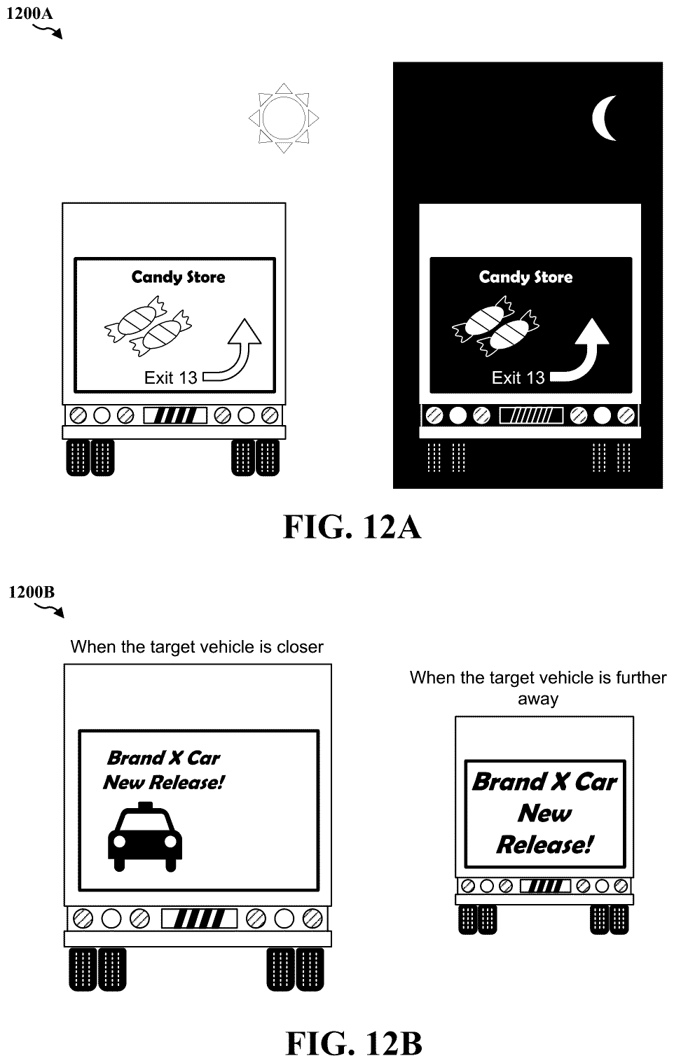

For example, as shown by a diagram 1200A of FIG. 12A, an advertisement vehicle (e.g., the advertisement vehicle 602, 802, 1002, 1102) may be configured to apply a first color setting/screen brightness during a day time (and/or sunny day), and apply a second color setting/screen brightness during a night time (and/or during rainy day). In another example, as shown by a diagram 1200B of FIG. 12B, an advertisement vehicle may be configured to display an advertisement to a target vehicle behind the advertisement vehicle using a smaller font (and with images) when the target vehicle is closer to the advertisement vehicle (e.g., is within a threshold distance of the advertisement vehicle). However, the advertisement vehicle may be configured to display the advertisement using a bigger font (and without images) when the target vehicle is further away from the advertisement vehicle (e.g., exceeds the threshold distance of the advertisement vehicle).

In another example, an advertisement vehicle (e.g., the advertisement vehicle 602, 802, 1002, 1102) may be configured to apply different settings/parameters for displaying an advertisement based on feature(s) associated with a target. For example, if a target is detected to be a kid, the advertisement vehicle may be configured to display an advertisement using a bigger font, an easier language, or a setting suitable for a kid (e.g., displaying the advertisement towards a lower angle). Similarly, if a target is detected to be an adult, the advertisement vehicle may be configured to display an advertisement using a regular font/language or a setting suitable for an adult (e.g., displaying the advertisement at a regular angle).

In some implementations, an advertisement vehicle (e.g., the advertisement vehicle 602, 802, 1002, 1102) may also be configured to adjust the displaying settings (e.g., brightness, angle, display size) based on the relative location and/or relative orientation of a target. For example, referring back to FIG. 11, based on detecting that the pedestrian 1106 is closer to the rear of the advertisement vehicle 1102, the advertisement vehicle 1102 may adjust the display angle and brightness of the display shown at 1112 to a setting that is most suitable for viewing from the stand point of the pedestrian 1106. Similarly, based on detecting that the pedestrian 1108 is a kid (or a person with certain height), the advertisement vehicle 1102 may adjust the display angle, height, and/or brightness of the display shown at 1114 to a setting that is most suitable for viewing from the stand point of the pedestrian 1108.

Aspects presented herein are directed to techniques/protocols for adaptive advertisements on vehicles. Aspects presented herein include at least the following features: (1) Selection of a vehicle display (among many such displays around the vehicle) and displaying an advertisement based on relative positioning measurements; (2) Location-specific advertisements where the vehicle display is configured to show a spatially-aware advertisement based on relative positioning measurements; (3) Advertisements shown on vehicle displays whose content is adapted according to the presence of user-owned devices (including cars, vehicles) in the vicinity.

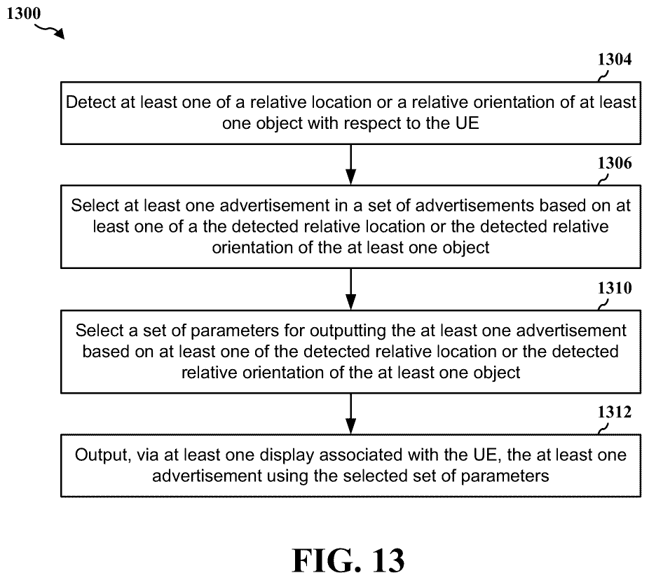

FIG. 13 is a flowchart 1300 of a method of wireless communication at a user equipment (UE). The method may be performed by a UE (e.g., the UE 104, 404; the vehicle 502; the advertisement vehicle 602, 802, 1002, 1102 apparatus 1504). The method may enable the UE to select a set of advertisements and/or parameter(s) for displaying the set of advertisements based on relative location and/or relative orientation of the target (e.g., a driver/passenger(s) of a vehicle, a pedestrian, a cyclist, a motorist, etc.).

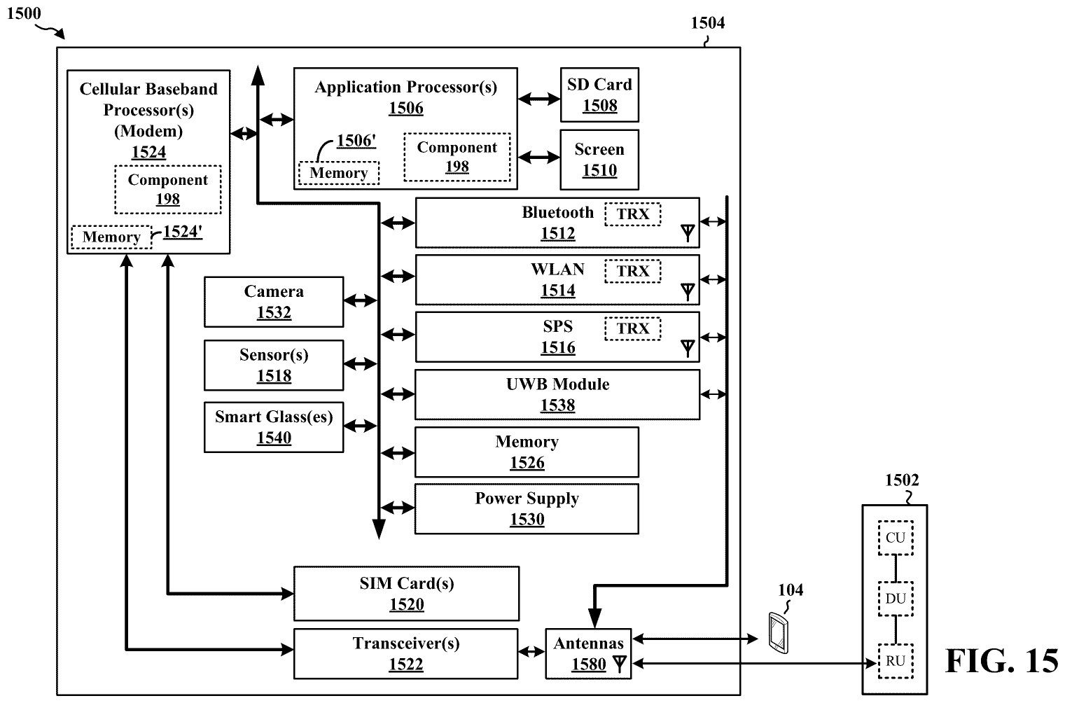

At 1304, the UE may detect at least one of a relative location or a relative orientation of at least one object with respect to the UE, such as described in connection with FIGS. 6 to 11, 12A, and 12B. For example, as discussed in connection with 614 of FIG. 6, the advertisement vehicle 602 may detect that a target vehicle 604 is in proximity (e.g., within a threshold/defined distance of the advertisement vehicle 602). Based on the detection, the advertisement vehicle 602 may also determine/calculate the location, the relative location, and/or the relative orientation or the target vehicle 604. The detection of at least one of the relative location or the relative orientation of at least one object with respect to the UE may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15.

In one example, to detect at least one of the relative location or the relative orientation of the at least one object with respect to the UE, the UE may perform a positioning measurement or a sensing measurement for a set of objects surrounding the UE, and determine a presence of the at least one object in the set of objects based on the positioning measurement or the sensing measurement.

In another example, the at least one object may include: at least one person, at least one vehicle, or a combination thereof.

At 1306, the UE may select at least one advertisement in a set of advertisements based on at least one of the detected relative location or the detected relative orientation of the at least one object, such as described in connection with FIGS. 6 to 11, 12A, and 12B. For example, utilizing the (relative) location/orientation information of the target vehicle 604, the advertisement vehicle 602 may select at least one of its displays to show/output one or more advertisements to the target vehicle 604. For example, as shown at 616 and 618, the advertisement vehicle 602 may use the first display 610 and the second display 612 to display an advertisement to the target vehicle 604. The advertisement vehicle 602 may also be configured to select the advertisement(s) from a set of advertisements (e.g., stored at a memory of the advertisement vehicle 602 or downloaded from a server) based on the location, relative location, relative orientation, and/or information related to the target vehicle 604. The selection of the at least one advertisement may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15.

In one example, the selection of the at least one advertisement in the set of advertisements is further based on at least one of: a time of a day, a weather condition, or an environmental condition.

In another example, the at least one advertisement may be associated with a subscription service, the UE may receive, from a server, the set of advertisements based on the subscription service.

In another example, the UE may be a vehicle, an on-board unit (OBU), a device running an advertisement application, or a display system.

At 1310, the UE may select a set of parameters for outputting the at least one advertisement based on at least one of the detected relative location or the detected relative orientation of the at least one object, such as described in connection with FIGS. 6 to 11, 12A, and 12B. For example, as discussed in connection with FIGS. 12A and 12B, an advertisement vehicle (e.g., the advertisement vehicle 602, 802, 1002, 1102) may be configured to select a set of parameters for displaying advertisement(s) based on the environmental condition(s), the time of the day, and/or the location/relative location/the relative orientation of the target. The selection of the set of parameters for outputting the at least one advertisement may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15.

In one example, the set of parameters for outputting the at least one advertisement may include at least one of: a display size for the at least one advertisement, an amount of information to be displayed for the at least one advertisement, a font size for the at least one advertisement, a set of colors to be used for the at least one advertisement, a display brightness for the at least one advertisement, or a display angle for the at least one advertisement.

In another example, to select the set of parameters for outputting the at least one advertisement based on at least one of the detected relative location or the detected relative orientation of the at least one object, the UE may select the set of parameters for outputting the at least one advertisement based on at least one of: a distance of the at least one object from the UE, a movement of the at least one object with respect to the UE, a height of the at least one object with respect to the UE, or a motion state associated with the UE.

In another example, the selection of the set of parameters for outputting the at least one advertisement may be further based on at least one of: a time of a day, a weather condition, an environmental condition, or a lighting condition.

At 1312, the UE may output, via at least one display associated with the UE, the at least one advertisement using the selected set of parameters, such as described in connection with FIGS. 6 to 11, 12A, and 12B. For example, as discussed in connection with 616 and 618 of FIG. 6, the advertisement vehicle 602 may use the first display 610 and the second display 612 to display an advertisement to the target vehicle 604. The output of the at least one advertisement may be performed by, e.g., the advertisement selection component 198, the screen 1510, the smart glass(es) 1540, the transceiver(s) 1522, the cellular baseband processor(s) 1524, and/or the application processor(s) 1506 of the apparatus 1504 in FIG. 15.

In one example, the UE may detect whether the at least one object is static or dynamic, and to output the at least one advertisement, the UE may display the at least one advertisement using at least one video if the at least one object is detected to be dynamic, or display the at least one advertisement using at least one static image if the at least one object is detected to be static.

In another example, to output, via the at least one display associated with the UE, the at least one advertisement using the selected set of parameters, the UE may select the at least one display from multiple displays for outputting the at least one advertisement, where the selection is based on at least one of the detected relative location or the detected relative orientation of the at least one object.

In another example, to output, via the at least one display associated with the UE, the at least one advertisement using the selected set of parameters, the UE may output, via a first display in the at least one display, a first advertisement in the at least one advertisement based on at least one of a first location or a first orientation of a first object in the at least one object, and output, via a second display in the at least one display, a second advertisement in the at least one advertisement based on at least one of a second location or a second orientation of a second object in the at least one object.

In another example, to output, via the at least one display, the at least one advertisement, the UE may output, via at least one external display of the UE that is facing towards the at least one object, the at least one advertisement.

In another example, the UE may identify, via at least one sensor or at least one camera, a set of features related to the at least one object, where the selection of the at least one advertisement or the selection of the set of parameters for outputting the at least one advertisement is further based on the identified set of features, such as described in connection with FIGS. 6 to 11, 12A, and 12B. For example, as discussed in connection with FIG. 10, the advertisement vehicle 1002 may also be configured to select one or more advertisements from a set of advertisements based on the location information of the advertisement vehicle 1002, the time information (e.g., the date, the time of the day, the season, etc.), and/or the target information. In another example, as described in connection with FIGS. 12A and 12B, an advertisement vehicle (e.g., the advertisement vehicle 602, 802, 1002, 1102) may be configured to select a set of parameters for displaying advertisement(s) based on the environmental condition(s), the time of the day, feature(s) associated with a target, and/or the location/relative location/the relative orientation of the target. The identification of the set of features related to the at least one object may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15. In some implementations, the set of features may include at least one of: an estimated age or age group, a gender, a height, a brand, a color, a condition, or a combination thereof.

In another example, the UE may track a movement of the at least one object, and modify the output of the at least one advertisement based on the tracked movement of the at least one object, such as described in connection with FIGS. 6 to 11, 12A, and 12B. For example, as discussed in connection with FIG. 6, the advertisement vehicle 602 may use the first display 610 to display the advertisement as shown at 616 while the target vehicle 604 is at the rear of the advertisement vehicle 602. When the target vehicle 604 is bypassing the advertisement vehicle 602 from the right, the advertisement vehicle 602 may switch (and resume) displaying the advertisement using the second display 612 as shown at 618. As such, the advertisement vehicle 602 may be configured to continuously track the movement (e.g., direction and orientation) of the target vehicle 604, and display the advertisement using a most suitable display (e.g., the one facing the target vehicle 604 or the one that is best viewed by the target vehicle, etc.) based on the movement of the target vehicle 604. The tracking of movement of the at least one object and/or the modification of the output of the at least one advertisement may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15. In some implementations, to modify the output of the at least one advertisement based on the tracked movement of the at least one object, the UE may display a relative direction between the at least one object and a location associated with the at least one advertisement based on the movement of the object.

In another example, the UE may receive, from a server, the set of advertisements or a set of updated advertisement based on a location of the UE, where the set of advertisements or the set of updated advertisement is related to one or more businesses within a threshold distance or a defined area of the UE, such as described in connection with FIGS. 6 to 11, 12A, and 12B. For example, as discussed in connection with 822 of FIG. 8, the advertisement vehicle 802 may continue to update its location with the server 806. Then, if the advertisement vehicle 802 is within a second threshold range (e.g., 3, kilometer, 1 kilometer, etc.) of the business 804, the server 806 may transmit and configure the advertisement vehicle 802 to display the advertisement for the business 804 (e.g., based on the on-demand update/inquiry/request discussed at 820). The detection of at least one of the relative location or the relative orientation of at least one object with respect to the UE may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15. In some implementations, the UE may estimate the location of the UE, and transmit, to the server, an indication of the estimated location of the UE. In some implementations, the UE may transmit, to the server, information related to the at least one object, where the reception of the set of advertisements may be further based on the information.

In another example, the UE may receive, from a server, an indication of an incentive or a compensation to display the at least one advertisement, where the output of the at least one advertisement may be further based on an acceptance of the incentive or the compensation.

In another example, the UE may receive a user input or a user desire to display the at least one advertisement, where the output of the at least one advertisement may be further based on the user input or the user desire.

In another example, the UE may obtain profile information of at least one second UE, where the at least one second UE is within a same ecosystem of the UE, where the output of the at least one advertisement may be further based on the profile information.

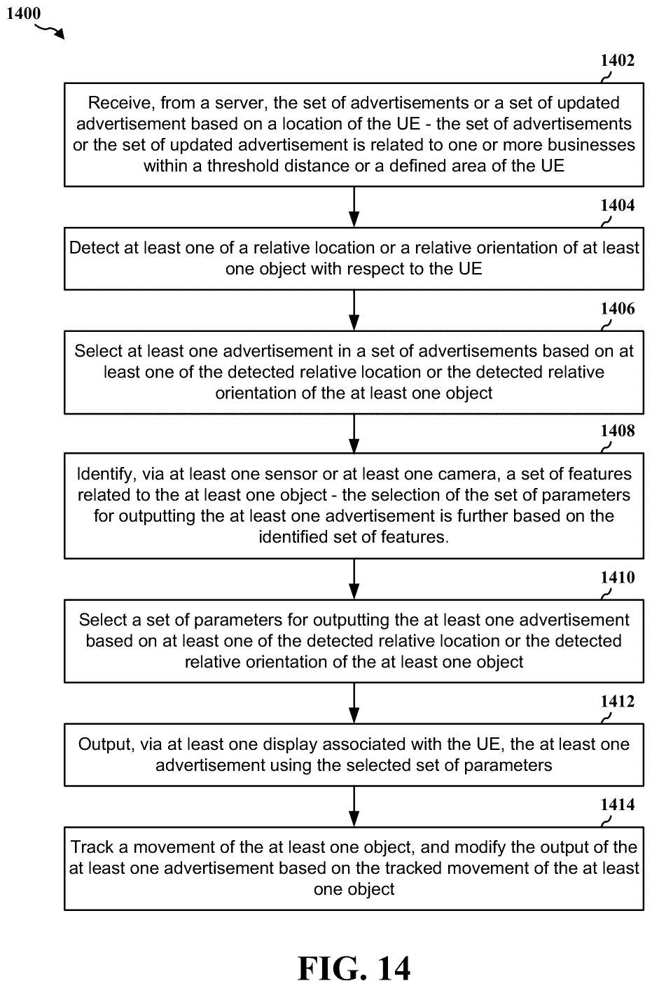

FIG. 14 is a flowchart 1400 of a method of wireless communication at a user equipment (UE). The method may be performed by a UE (e.g., the UE 104, 404; the vehicle 502; the advertisement vehicle 602, 802, 1002, 1102 apparatus 1504). The method may enable the UE to select and display a set of advertisement based on location, relative location, and/or relative orientation of a target (e.g., another vehicle, a pedestrian, a cyclist, a motorist, etc.).

At 1404, the UE may detect at least one of a relative location or a relative orientation of at least one object with respect to the UE, such as described in connection with FIGS. 6 to 11, 12A, and 12B. For example, as discussed in connection with 614 of FIG. 6, the advertisement vehicle 602 may detect that a target vehicle 604 is in proximity (e.g., within a threshold/defined distance of the advertisement vehicle 602). Based on the detection, the advertisement vehicle 602 may also determine/calculate the location, the relative location, and/or the relative orientation or the target vehicle 604. The detection of at least one of the relative location or the relative orientation of at least one object with respect to the UE may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15.

In one example, to detect at least one of the relative location or the relative orientation of the at least one object with respect to the UE, the UE may perform a positioning measurement or a sensing measurement for a set of objects surrounding the UE, and determine a presence of the at least one object in the set of objects based on the positioning measurement or the sensing measurement.

In another example, the at least one object includes: at least one person, at least one vehicle, or a combination thereof.

At 1406, the UE may select at least one advertisement in a set of advertisements based on at least one of the detected relative location or the detected relative orientation of the at least one object, such as described in connection with FIGS. 6 to 11, 12A, and 12B. For example, utilizing the (relative) location/orientation information of the target vehicle 604, the advertisement vehicle 602 may select at least one of its displays to show/output one or more advertisements to the target vehicle 604. For example, as shown at 616 and 618, the advertisement vehicle 602 may use the first display 610 and the second display 612 to display an advertisement to the target vehicle 604. The advertisement vehicle 602 may also be configured to select the advertisement(s) from a set of advertisements (e.g., stored at a memory of the advertisement vehicle 602 or downloaded from a server) based on the location, relative location, relative orientation, and/or information related to the target vehicle 604. The selection of the at least one advertisement may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15.

In one example, the selection of the at least one advertisement in the set of advertisements may be further based on at least one of: a time of a day, a weather condition, or an environmental condition.

In another example, the at least one advertisement may be associated with a subscription service, the UE may receive, from a server, the set of advertisements based on the subscription service.

In another example, the UE may be a vehicle, an OBU, a device running an advertisement application, or a display system.

At 1410, the UE may select a set of parameters for outputting the at least one advertisement based on at least one of the detected relative location or the detected relative orientation of the at least one object, such as described in connection with FIGS. 6 to 11, 12A, and 12B. For example, as discussed in connection with FIGS. 12A and 12B, an advertisement vehicle (e.g., the advertisement vehicle 602, 802, 1002, 1102) may be configured to select a set of parameters for displaying advertisement(s) based on the environmental condition(s), the time of the day, and/or the location/relative location/the relative orientation of the target. The selection of the set of parameters for outputting the at least one advertisement may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15.

In one example, the set of parameters for outputting the at least one advertisement may include at least one of: a display size for the at least one advertisement, an amount of information to be displayed for the at least one advertisement, a font size for the at least one advertisement, a set of colors to be used for the at least one advertisement, a display brightness for the at least one advertisement, or a display angle for the at least one advertisement.

In another example, to select the set of parameters for outputting the at least one advertisement based on at least one of the detected relative location or the detected relative orientation of the at least one object, the UE may select the set of parameters for outputting the at least one advertisement based on at least one of: a distance of the at least one object from the UE, a movement of the at least one object with respect to the UE, a height of the at least one object with respect to the UE, or a motion state associated with the UE.

In another example, the selection of the set of parameters for outputting the at least one advertisement may be further based on at least one of: a time of a day, a weather condition, an environmental condition, or a lighting condition.

At 1412, the UE may output, via at least one display associated with the UE, the at least one advertisement using the selected set of parameters, such as described in connection with FIGS. 6 to 11, 12A, and 12B. For example, as discussed in connection with 616 and 618 of FIG. 6, the advertisement vehicle 602 may use the first display 610 and the second display 612 to display an advertisement to the target vehicle 604. The output of the at least one advertisement may be performed by, e.g., the advertisement selection component 198, the screen 1510, the smart glass(es) 1518, the transceiver(s) 1522, the cellular baseband processor(s) 1524, and/or the application processor(s) 1506 of the apparatus 1504 in FIG. 15.

In one example, the UE may detect whether the at least one object is static or dynamic, and to output the at least one advertisement, the UE may display the at least one advertisement using at least one video if the at least one object is detected to be dynamic, or display the at least one advertisement using at least one static image if the at least one object is detected to be static.

In another example, to output, via the at least one display associated with the UE, the at least one advertisement using the selected set of parameters, the UE may select the at least one display from multiple displays for outputting the at least one advertisement, where the selection is based on at least one of the detected relative location or the detected relative orientation of the at least one object.

In another example, to output, via the at least one display associated with the UE, the at least one advertisement using the selected set of parameters, the UE may output, via a first display in the at least one display, a first advertisement in the at least one advertisement based on at least one of a first location or a first orientation of a first object in the at least one object, and output, via a second display in the at least one display, a second advertisement in the at least one advertisement based on at least one of a second location or a second orientation of a second object in the at least one object.

In another example, to output, via the at least one display, the at least one advertisement, the UE may output, via at least one external display of the UE that is facing towards the at least one object, the at least one advertisement.

In another example, as shown at 1408, the UE may identify, via at least one sensor or at least one camera, a set of features related to the at least one object, where the selection of the at least one advertisement or the selection of the set of parameters for outputting the at least one advertisement is further based on the identified set of features, such as described in connection with FIGS. 6 to 11, 12A, and 12B. For example, as discussed in connection with FIG. 10, the advertisement vehicle 1002 may also be configured to select one or more advertisements from a set of advertisements based on the location information of the advertisement vehicle 1002, the time information (e.g., the date, the time of the day, the season, etc.), and/or the target information. In another example, as described in connection with FIGS. 12A and 12B, an advertisement vehicle (e.g., the advertisement vehicle 602, 802, 1002, 1102) may be configured to select a set of parameters for displaying advertisement(s) based on the environmental condition(s), the time of the day, feature(s) associated with a target, and/or the location/relative location/the relative orientation of the target. The identification of the set of features related to the at least one object may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15. In some implementations, the set of features may include at least one of: an estimated age or age group, a gender, a height, a brand, a color, a condition, or a combination thereof.

In another example, as shown at 1414, the UE may track a movement of the at least one object, and modify the output of the at least one advertisement based on the tracked movement of the at least one object, such as described in connection with FIGS. 6 to 11, 12A, and 12B. For example, as discussed in connection with FIG. 6, the advertisement vehicle 602 may use the first display 610 to display the advertisement as shown at 616 while the target vehicle 604 is at the rear of the advertisement vehicle 602. When the target vehicle 604 is bypassing the advertisement vehicle 602 from the right, the advertisement vehicle 602 may switch (and resume) displaying the advertisement using the second display 612 as shown at 618. As such, the advertisement vehicle 602 may be configured to continuously track the movement (e.g., direction and orientation) of the target vehicle 604, and display the advertisement using a most suitable display (e.g., the one facing the target vehicle 604 or the one that is best viewed by the target vehicle, etc.) based on the movement of the target vehicle 604. The tracking of movement of the at least one object and/or the modification of the output of the at least one advertisement may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15. In some implementations, to modify the output of the at least one advertisement based on the tracked movement of the at least one object, the UE may display a relative direction between the at least one object and a location associated with the at least one advertisement based on the movement of the object.

In another example, as shown at 1402, the UE may receive, from a server, the set of advertisements or a set of updated advertisement based on a location of the UE, where the set of advertisements or the set of updated advertisement is related to one or more businesses within a threshold distance or a defined area of the UE, such as described in connection with FIGS. 6 to 11, 12A, and 12B. For example, as discussed in connection with 822 of FIG. 8, the advertisement vehicle 802 may continue to update its location with the server 806. Then, if the advertisement vehicle 802 is within a second threshold range (e.g., 3, kilometer, 1 kilometer, etc.) of the business 804, the server 806 may transmit and configure the advertisement vehicle 802 to display the advertisement for the business 804 (e.g., based on the on-demand update/inquiry/request discussed at 820). The detection of at least one of the relative location or the relative orientation of at least one object with respect to the UE may be performed by, e.g., the advertisement selection component 198, the camera 1532, the one or more sensors 1518, the transceiver(s) 1522, the cellular baseband processor(s) 1524, and/or the application processor(s) 1506 of the apparatus 1504 in FIG. 15. In some implementations, the UE may estimate the location of the UE, and transmit, to the server, an indication of the estimated location of the UE. In some implementations, the UE may transmit, to the server, information related to the at least one object, where the reception of the set of advertisements may be further based on the information.

In another example, the UE may receive, from a server, an indication of an incentive or a compensation to display the at least one advertisement, where the output of the at least one advertisement may be further based on an acceptance of the incentive or the compensation.

In another example, the UE may receive a user input or a user desire to display the at least one advertisement, where the output of the at least one advertisement may be further based on the user input or the user desire.

In another example, the UE may obtain profile information of at least one second UE, where the at least one second UE is within a same ecosystem of the UE, where the output of the at least one advertisement may be further based on the profile information.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an ultrawide band (UWB) module 1538, an SPS module 1516 (e.g., GNSS module), smart glass(es) 1540, one or more sensors 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the UWB module 1538, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the advertisement selection component 198 may be configured to detect at least one of a relative location or a relative orientation of at least one object with respect to the UE. The advertisement selection component 198 may also be configured to select at least one advertisement in a set of advertisements based on at least one of the detected relative location or the detected relative orientation of the at least one object. The advertisement selection component 198 may also be configured to select a set of parameters for outputting the at least one advertisement based on at least one of the detected relative location or the detected relative orientation of the at least one object. The advertisement selection component 198 may also be configured to output, via at least one display associated with the UE, the at least one advertisement using the selected set of parameters. The advertisement selection component 198 may be within the cellular baseband processor(s) 1524, the application processor(s) 1506, or both the cellular baseband processor(s) 1524 and the application processor(s) 1506. The advertisement selection component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for detecting at least one of a relative location or a relative orientation of at least one object with respect to the UE. The apparatus 1504 may further include means for selecting at least one advertisement in a set of advertisements based on at least one of the detected relative location or the detected relative orientation of the at least one object. The apparatus 1504 may further include means for selecting a set of parameters for outputting the at least one advertisement based on at least one of the detected relative location or the detected relative orientation of the at least one object. The apparatus 1504 may further include means for outputting, via at least one display associated with the UE, the at least one advertisement using the selected set of parameters.

In one configuration, the means for detecting at least one of the relative location or the relative orientation of the at least one object with respect to the apparatus 1504 may include configuring the apparatus 1504 to perform a positioning measurement or a sensing measurement for a set of objects surrounding the apparatus 1504, and determine a presence of the at least one object in the set of objects based on the positioning measurement or the sensing measurement.

In another configuration, the at least one object includes: at least one person, at least one vehicle, or a combination thereof.

In another configuration, the selection of the at least one advertisement in the set of advertisements is further based on at least one of: a time of a day, a weather condition, or an environmental condition.

In another configuration, the at least one advertisement is associated with a subscription service, the apparatus 1504 may further include means for receiving, from a server, the set of advertisements based on the subscription service.

In another configuration, the apparatus 1504 may be a vehicle, an OBU, a device running an advertisement application, or a display system.

In another configuration, the set of parameters for outputting the at least one advertisement may include at least one of: a display size for the at least one advertisement, an amount of information to be displayed for the at least one advertisement, a font size for the at least one advertisement, a set of colors to be used for the at least one advertisement, a display brightness for the at least one advertisement, or a display angle for the at least one advertisement.

In another configuration, the means for selecting the set of parameters for outputting the at least one advertisement based on at least one of the detected relative location or the detected relative orientation of the at least one object may include configuring the apparatus 1504 to select the set of parameters for outputting the at least one advertisement based on at least one of: a distance of the at least one object from the apparatus 1504, a movement of the at least one object with respect to the apparatus 1504, a height of the at least one object with respect to the apparatus 1504, or a motion state associated with the apparatus 1504.

In another configuration, the selection of the set of parameters for outputting the at least one advertisement may be further based on at least one of: a time of a day, a weather condition, an environmental condition, or a lighting condition.

In another configuration, the apparatus 1504 may further include means for detecting whether the at least one object is static or dynamic, and the means for outputting the at least one advertisement may include configuring the apparatus 1504 to display the at least one advertisement using at least one video if the at least one object is detected to be dynamic, or display the at least one advertisement using at least one static image if the at least one object is detected to be static.

In another configuration, the means for outputting, via the at least one display associated with the apparatus 1504, the at least one advertisement using the selected set of parameters may include configuring the apparatus 1504 to select the at least one display from multiple displays for outputting the at least one advertisement, where the selection is based on at least one of the detected relative location or the detected relative orientation of the at least one object.

In another configuration, the means for outputting, via the at least one display associated with the apparatus 1504, the at least one advertisement using the selected set of parameters may include configuring the apparatus 1504 to output, via a first display in the at least one display, a first advertisement in the at least one advertisement based on at least one of a first location or a first orientation of a first object in the at least one object, and output, via a second display in the at least one display, a second advertisement in the at least one advertisement based on at least one of a second location or a second orientation of a second object in the at least one object.

In another configuration, the means for outputting, via the at least one display, the at least one advertisement may include configuring the apparatus 1504 to output, via at least one external display of the apparatus 1504 that is facing towards the at least one object, the at least one advertisement.

In another configuration, the apparatus 1504 may further include means for identifying, via at least one sensor or at least one camera, a set of features related to the at least one object, where the selection of the at least one advertisement or the selection of the set of parameters for outputting the at least one advertisement is further based on the identified set of features. In some implementations, the set of features may include at least one of: an estimated age or age group, a gender, a height, a brand, a color, a condition, or a combination thereof.

In another configuration, the apparatus 1504 may further include means for tracking a movement of the at least one object, and means for modifying the output of the at least one advertisement based on the tracked movement of the at least one object. In some implementations, the means for modifying the output of the at least one advertisement based on the tracked movement of the at least one object may include configuring the apparatus 1504 to display a relative direction between the at least one object and a location associated with the at least one advertisement based on the movement of the object.

In another configuration, the apparatus 1504 may further include means for receiving, from a server, the set of advertisements or a set of updated advertisement based on a location of the apparatus 1504, where the set of advertisements or the set of updated advertisement is related to one or more businesses within a threshold distance or a defined area of the apparatus 1504. In some implementations, the apparatus 1504 may further include means for estimating the location of the apparatus 1504, and means for transmitting, to the server, an indication of the estimated location of the apparatus 1504. In some implementations, the apparatus 1504 may further include means for transmitting, to the server, information related to the at least one object, where the reception of the set of advertisements may be further based on the information.

In another configuration, the apparatus 1504 may further include means for receiving, from a server, an indication of an incentive or a compensation to display the at least one advertisement, where the output of the at least one advertisement may be further based on an acceptance of the incentive or the compensation.

In another configuration, the apparatus 1504 may further include means for receiving a user input or a user desire to display the at least one advertisement, where the output of the at least one advertisement may be further based on the user input or the user desire.

In another configuration, the apparatus 1504 may further include means for obtaining profile information of at least one second UE, where the at least one second UE is within a same ecosystem of the apparatus 1504, where the output of the at least one advertisement may be further based on the profile information.

The means may be the advertisement selection component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: detecting at least one of a relative location or a relative orientation of at least one object with respect to the UE; selecting at least one advertisement in a set of advertisements based on at least one of the detected relative location or the detected relative orientation of the at least one object; selecting a set of parameters for outputting the at least one advertisement based on at least one of the detected relative location or the detected relative orientation of the at least one object; and outputting, via at least one display associated with the UE, the at least one advertisement using the selected set of parameters.

Aspect 2 is the method of aspect 1, wherein the set of parameters for outputting the at least one advertisement includes at least one of: a display size for the at least one advertisement, an amount of information to be displayed for the at least one advertisement, a font size for the at least one advertisement, a set of colors to be used for the at least one advertisement, a display brightness for the at least one advertisement, or a display angle for the at least one advertisement.

Aspect 3 is the method of aspect 1 or aspect 2, wherein selecting the set of parameters for outputting the at least one advertisement based on at least one of the detected relative location or the detected relative orientation of the at least one object comprises: selecting the set of parameters for outputting the at least one advertisement based on at least one of: a distance of the at least one object from the UE, a movement of the at least one object with respect to the UE, a height of the at least one object with respect to the UE, or a motion state associated with the UE.

Aspect 4 is the method of any of aspects 1 to 3, further comprising: identifying, via at least one sensor or at least one camera, a set of features related to the at least one object, wherein the selection of the set of parameters for outputting the at least one advertisement is further based on the identified set of features.

Aspect 5 is the method of any of aspects 1 to 4, wherein the set of features includes at least one of: an estimated age or age group, a gender, a height, a brand, a color, a condition, or a combination thereof.

Aspect 6 is the method of any of aspects 1 to 5, further comprising: detecting whether the at least one object is static or dynamic, wherein the selected set of parameters includes: displaying the at least one advertisement using at least one video if the at least one object is detected to be dynamic; or displaying the at least one advertisement using at least one static image if the at least one object is detected to be static.

Aspect 7 is the method of any of aspects 1 to 6, further comprising: tracking a movement of the at least one object; and modifying the output of the at least one advertisement based on the tracked movement of the at least one object.

Aspect 8 is the method of any of aspects 1 to 7, wherein modifying the output of the at least one advertisement based on the tracked movement of the at least one object comprises: displaying a relative direction between the at least one object and a location associated with the at least one advertisement based on the movement of the object.

Aspect 9 is the method of any of aspects 1 to 8, wherein outputting, via the at least one display associated with the UE, the at least one advertisement using the selected set of parameters comprises: selecting the at least one display from multiple displays for outputting the at least one advertisement, wherein the selection is based on at least one of the detected relative location or the detected relative orientation of the at least one object.

Aspect 10 is the method of any of aspects 1 to 9, wherein detecting at least one of the relative location or the relative orientation of the at least one object with respect to the UE comprises: performing a positioning measurement or a sensing measurement for a set of objects surrounding the UE; and determining a presence of the at least one object in the set of objects based on the positioning measurement or the sensing measurement.

Aspect 11 is the method of any of aspects 1 to 10, wherein outputting, via the at least one display associated with the UE, the at least one advertisement using the selected set of parameters comprises: outputting, via a first display in the at least one display, a first advertisement in the at least one advertisement based on at least one of a first location or a first orientation of a first object in the at least one object; and outputting, via a second display in the at least one display, a second advertisement in the at least one advertisement based on at least one of a second location or a second orientation of a second object in the at least one object.

Aspect 12 is the method of any of aspects 1 to 11, wherein outputting, via the at least one display, the at least one advertisement comprises: outputting, via at least one external display of the UE that is facing towards the at least one object, the at least one advertisement.

Aspect 13 is the method of any of aspects 1 to 12, wherein the selection of the set of parameters for outputting the at least one advertisement is further based on at least one of: a time of a day, a weather condition, an environmental condition, or a lighting condition.

Aspect 14 is the method of any of aspects 1 to 13, wherein the selection of the at least one advertisement in the set of advertisements is further based on at least one of: a time of a day, a weather condition, or an environmental condition.

Aspect 15 is the method of any of aspects 1 to 14, wherein the at least one object includes: at least one person, at least one vehicle, or a combination thereof.

Aspect 16 is the method of any of aspects 1 to 15, further comprising: receiving, from a server, the set of advertisements or a set of updated advertisement based on a location of the UE, wherein the set of advertisements or the set of updated advertisement is related to one or more businesses within a threshold distance or a defined area of the UE.

Aspect 17 is the method of any of aspects 1 to 16, further comprising: estimating the location of the UE; and transmitting, to the server, an indication of the estimated location of the UE.

Aspect 18 is the method of any of aspects 1 to 17, further comprising: transmitting, to the server, information related to the at least one object, wherein the reception of the set of advertisements is further based on the information.

Aspect 19 is the method of any of aspects 1 to 18, wherein the at least one advertisement is associated with a subscription service, the method further comprising: receiving, from a server, the set of advertisements based on the subscription service.

Aspect 20 is the method of any of aspects 1 to 19, further comprising: receiving, from a server, an indication of an incentive or a compensation to display the at least one advertisement, wherein the output of the at least one advertisement is further based on an acceptance of the incentive or the compensation.

Aspect 21 is the method of any of aspects 1 to 20, further comprising: receiving a user input or a user desire to display the at least one advertisement, wherein the output of the at least one advertisement is further based on the user input or the user desire.

Aspect 22 is the method of any of aspects 1 to 21, further comprising: obtaining profile information of at least one second UE, wherein the at least one second UE is within a same ecosystem of the UE, wherein the output of the at least one advertisement is further based on the profile information.

Aspect 23 is the method of any of aspects 1 to 22, wherein the UE is a vehicle, an on-board unit (OBU), a device running an advertisement application, or a display system.

Aspect 24 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 23.

Aspect 25 is the apparatus of aspect 24, further including at least one transceiver coupled to the at least one processor.

Aspect 26 is an apparatus for wireless communication at a user equipment (UE), including means for implementing any of aspects 1 to 23.

Aspect 27 is a computer-readable medium (e.g., a non-transitory computer-readable medium) storing computer executable code, where the code when executed by a processor causes the processor to implement any of aspects 1 to 23.

What is claimed is:

1. An apparatus for wireless communication at a user equipment (UE), comprising:
at least one memory; and
at least one processor coupled to the at least one memory, the at least one processor, individually or in any combination, is configured to:
detect at least one of a relative location or a relative orientation of at least one object with respect to the UE;
select at least one advertisement in a set of advertisements based on at least one of the detected relative location or the detected relative orientation of the at least one object;
select a set of parameters for outputting the at least one advertisement based on at least one of the detected relative location or the detected relative orientation of the at least one object; and
output, via at least one display associated with the UE, the at least one advertisement using the selected set of parameters.

2. The apparatus of claim 1, wherein the set of parameters for outputting the at least one advertisement includes at least one of:
a display size for the at least one advertisement,
an amount of information to be displayed for the at least one advertisement,
a font size for the at least one advertisement,
a set of colors to be used for the at least one advertisement,
a display brightness for the at least one advertisement, or
a display angle for the at least one advertisement.

3. The apparatus of claim 1, wherein to select the set of parameters for outputting the at least one advertisement based on at least one of the detected relative location or the detected relative orientation of the at least one object, the at least one processor, individually or in any combination, is configured to:
select the set of parameters for outputting the at least one advertisement based on at least one of:
a distance of the at least one object from the UE,
a movement of the at least one object with respect to the UE,
a height of the at least one object with respect to the UE, or
a motion state associated with the UE.

4. The apparatus of claim 1, wherein the at least one processor, individually or in any combination, is further configured to:
identify, via at least one sensor or at least one camera, a set of features related to the at least one object, wherein the selection of the set of parameters for outputting the at least one advertisement is further based on the identified set of features.

5. The apparatus of claim 1, wherein the at least one processor, individually or in any combination, is further configured to detect whether the at least one object is static or dynamic, wherein to output the at least one advertisement using the selected set of parameters, the at least one processor, individually or in any combination, is configured to:
display the at least one advertisement using at least one video if the at least one object is detected to be dynamic; or
display the at least one advertisement using at least one static image if the at least one object is detected to be static.

6. The apparatus of claim 1, wherein the at least one processor, individually or in any combination, is further configured to:
track a movement of the at least one object; and
modify the output of the at least one advertisement based on the tracked movement of the at least one object.

7. The apparatus of claim 6, wherein to modify the output of the at least one advertisement based on the tracked movement of the at least one object, the at least one processor, individually or in any combination, is configured to:
display a relative direction between the at least one object and a location associated with the at least one advertisement based on the movement of the object.

8. The apparatus of claim 1, wherein to output, via the at least one display associated with the UE, the at least one advertisement using the selected set of parameters, the at least one processor, individually or in any combination, is configured to:
select the at least one display from multiple displays for outputting the at least one advertisement, wherein the selection is based on at least one of the detected relative location or the detected relative orientation of the at least one object.

9. The apparatus of claim 1, wherein to detect at least one of the relative location or the relative orientation of the at least one object with respect to the UE, the at least one processor, individually or in any combination, is configured to:
perform a positioning measurement or a sensing measurement for a set of objects surrounding the UE; and
determine a presence of the at least one object in the set of objects based on the positioning measurement or the sensing measurement.

10. The apparatus of claim 1, wherein to output, via the at least one display associated with the UE, the at least one advertisement using the selected set of parameters, the at least one processor, individually or in any combination, is configured to:
output, via a first display in the at least one display, a first advertisement in the at least one advertisement based on at least one of a first location or a first orientation of a first object in the at least one object; and
output, via a second display in the at least one display, a second advertisement in the at least one advertisement based on at least one of a second location or a second orientation of a second object in the at least one object.

11. The apparatus of claim 1, wherein the selection of the at least one advertisement in the set of advertisements or the selection of the set of parameters for outputting the at least one advertisement is further based on at least one of:
a time of a day,
a weather condition,
an environmental condition, or
a lighting condition.

12. The apparatus of claim 1, wherein the at least one processor, individually or in any combination, is further configured to:
receive a user input or a user desire to display the at least one advertisement, wherein the output of the at least one advertisement is further based on the user input or the user desire.

13. The apparatus of claim 1, wherein the at least one processor, individually or in any combination, is further configured to:
obtain profile information of at least one second UE, wherein the at least one second UE is within a same ecosystem of the UE, wherein the output of the at least one advertisement is further based on the profile information.

14. A method of wireless communication at a user equipment (UE), comprising:
detecting at least one of a relative location or a relative orientation of at least one object with respect to the UE;
selecting at least one advertisement in a set of advertisements based on at least one of the detected relative location or the detected relative orientation of the at least one object;
selecting a set of parameters for outputting the at least one advertisement based on at least one of the detected relative location or the detected relative orientation of the at least one object; and
outputting, via at least one display associated with the UE, the at least one advertisement using the selected set of parameters.

15. The method of claim 14, wherein the set of parameters for outputting the at least one advertisement includes at least one of:
a display size for the at least one advertisement,
an amount of information to be displayed for the at least one advertisement,
a font size for the at least one advertisement,
a set of colors to be used for the at least one advertisement,
a display brightness for the at least one advertisement, or
a display angle for the at least one advertisement.

16. The method of claim 14, wherein selecting the set of parameters for outputting the at least one advertisement based on at least one of the detected relative location or the detected relative orientation of the at least one object comprises:
selecting the set of parameters for outputting the at least one advertisement based on at least one of:
a distance of the at least one object from the UE,
a movement of the at least one object with respect to the UE,
a height of the at least one object with respect to the UE, or
a motion state associated with the UE.

17. The method of claim 14, further comprising:
detecting whether the at least one object is static or dynamic, wherein outputting the at least one advertisement using the selected set of parameters comprises:
displaying the at least one advertisement using at least one video if the at least one object is detected to be dynamic; or
displaying the at least one advertisement using at least one static image if the at least one object is detected to be static.

18. The method of claim 14, further comprising:
tracking a movement of the at least one object; and
modifying the output of the at least one advertisement based on the tracked movement of the at least one object.

19. The method of claim 14, further comprising:
obtaining profile information of at least one second UE, wherein the at least one second UE is within a same ecosystem of the UE, wherein the output of the at least one advertisement is further based on the profile information.

20. An apparatus for wireless communication at a user equipment (UE), comprising:
means for detecting at least one of a relative location or a relative orientation of at least one object with respect to the UE;
means for selecting at least one advertisement in a set of advertisements based on at least one of the detected relative location or the detected relative orientation of the at least one object;
means for selecting a set of parameters for outputting the at least one advertisement based on at least one of the detected relative location or the detected relative orientation of the at least one object; and
means for outputting, via at least one display associated with the UE, the at least one advertisement using the selected set of parameters.
